(19) United States
(12) Patent Application Publication
(10) Pub. No.: US 2026/0084958 A1
(43) Pub. Date: Mar. 26, 2026

(54) HIGH PRESSURE AND LOW TEMPERATURE RECYCLED NH3 REFORMING PROCESS

(71) Applicant: BASF SE, Ludwigshafen am Rhein (DE)

(72) Inventors: Elias Christopher FREI, Ludwigshafen am Rhein (DE); Matthias FELISCHAK, Ludwigshafen am Rhein (DE); Lukasz KARWACKI, Ludwigshafen am Rhein (DE); Nils BOTTKE, Ludwigshafen am Rhein (DE)

(21) Appl. No.: 19/110,976

(22) PCT Filed: Sep. 15, 2023
(86) PCT No.: PCT/EP2023/075517

§ 371 Date: Mar. 12, 2025

(30) Foreign Application Priority Data
Sep. 16, 2022 (EP) 22196170.9

(51) Int. Cl. C01B 3/04

(52) U.S. Cl. CPC C01B 3/047; C01B 2203/0277; C01B 2203/04; C01B 2203/1064; C01B 2203/1205

(57) ABSTRACT

The present invention relates to a process for NHI; reforming, the process comprising (i) feeding a feed stream comprising NH₃ into a reactor unit, wherein the reactor unit has a reactor unit inlet and a reactor unit outlet, wherein the reactor unit comprises a catalytic material: (ii) contacting the feed stream with the catalytic material in the reactor unit, for obtaining a product stream comprising H₂, N₂, NH₃, and optionally H₂O, wherein contacting is performed at a pressure in the range of from 1 to 100 bar(abs) and at a temperature in the range of from 50 to 750° C.; (iii) optionally separating H₂O in the product stream obtained in (ii) for obtaining a dehydrated product stream comprising H₂, N₂, and NH₃; (iv) separating NH₃ from the product stream obtained in (ii) or from the dehydrated product stream obtained in (iii) for obtaining a purified product stream comprising N₂ and H₂: (v) recycling the separated NH₃ obtained in (iv) to (i).

### TECHNICAL FIELD

The present invention relates to a process for reforming NH₃ at a high pressure and at a low temperature in a recycle concept. Especially, the not reacted NH₃ from the reactor outlet will be separated and recycled to the reactor inlet. The hydrogen comprised in the product stream is extracted under the high-pressure reaction conditions.

### INTRODUCTION

NH₃ is seen as an energy vector of the future, able to store chemically significant amounts of H₂. The reforming of NH₃ according to formula (I) is the final step in including the hydrogen back into chemical processes or other applications. Since the NH₃ reforming step itself is an endothermic reaction (45.6 KJ/mol), additional energy must be invested. Also, the evaporation from liquid to gaseous NH₃ should be considered as an energy intense step (23 kJ/mol).

$${NH}_{3} ⇌ 0.5 {N}_{2} + 1.5 {H}_{2} \qquad ( I )$$

The endothermic character of the reforming step favors high temperatures for achieving a high NH₃ conversion rate. However, thermodynamic limitations must be considered in this respect. This applies in particular for the pressure, since high pressures are typically not wanted in view of thermodynamic constraints. From the perspective of hydrogen as target product high pressures would, however, be of advantage. The process of the present invention generally follows a NH₃ reforming concept, where afterwards NH₃ is separated from the reactor outlet stream and fed back into the reactor inlet, thus, allowing a process design avoiding certain restrictions. In particular, combinations of temperature and pressure settings, dependent on the downstream application, can be applied for the inventive process design. For instance, a combination of low-temperature and high-pressure conditions can be applied.

U.S. Pat. No. 8,961,923 B2 relates to an autothermal ammonia cracker. Disclosed is a process for auto-thermally cracking ammonia with air or oxygen, wherein the ammonia- and oxygen-containing gas mixture is preferably combusted at specific combinations of temperature and pressure, e.g. at a temperature higher than 1200° C. and a pressure of 10 bars or at a temperature of 1300° C. and a pressure of 1 bar.

U.S. Pat. No. 8,691,182 B2 relates to a method of cracking ammonia, wherein a mixture of ammonia and an oxygen-containing gas is combusted. The combustion takes preferably place at a temperature of higher than 1100° C. and preferably at a pressure of about 1 atmosphere.

U.S. Pat. No. 8,464,515 B2 relates to an ammonia burning internal combustion engine. The combustion engine comprises in particular a reformer for reforming of ammonia which is located upstream of a combustion chamber.

U.S. Pat. No. 2,578,193 discloses an ammonia dissociator, wherein dissociation of ammonia can be carried out at a temperature of about 650° C. (1200° F.).

WO 2019/038251 A1 relates to an autothermal ammonia cracking process. In particular, a process is disclosed therein for the production of a product gas containing nitrogen and hydrogen from ammonia comprising the steps of non-catalytic partial oxidation of ammonia with an oxygen containing gas.

Banares-Alcantara et al. disclose in Applied Energy 2021, 282, 116009 a forecast of ammonia as energy carrier, in particular its role in combined cycle gas turbines for power generation. In particular, a modelled NH₃ reformer is disclosed therein, having an assumed conversion of 99% at 850° C.

As noted above, the NH₃ reforming process is an endothermic and volume increasing equilibrium reaction. This means to reach high conversion, low pressure and high temperatures are needed. However, with respect to the use of hydrogen obtained from NH₃ reforming it is typically required to provide a hydrogen stream having a comparatively high pressure and a comparatively low temperature. Thus, there was a need to provide a novel process wherein a product stream from NH₃ reforming can be obtained having a comparatively high pressure and a comparatively low temperature.

### DETAILED DESCRIPTION

Thus, it has surprisingly been found that an inventive process can be provided for producing a hydrogen-containing stream having a comparatively high pressure, or a comparatively high pressure and a comparatively low temperature. In particular, the present invention allows a process design wherein especially the tubings are small, and according to which the hydrogen is particularly produced at high pressures, whereby the temperature is in particular comparably low and the space for the plant can be rather small.

The advantage of this recycle process concept is to circumvent the thermodynamic limitations and to develop a dedicated compact process design for any downstream application. In particular, the process of the present invention is advantageous with respect to resource- and energy efficiency, especially to its operating expenses, considering low reaction temperatures coupled to a high pressure H₂ product.

In particular, the NH₃ reforming process according to the present invention, characterized by a recycle mode, allows a process design which overcomes thermodynamic limitations with respect to temperature and pressure. This allows a dedicated process design for any downstream application and offers low OPEX and CAPEX solutions for the NH₃ reforming process.

Therefore, the present invention relates to a process for NH₃ reforming, the process comprising
(i) feeding a feed stream comprising NH₃ into a reactor unit, wherein the reactor unit has a reactor unit inlet and a reactor unit outlet, wherein the reactor unit comprises a catalytic material;
(ii) contacting the feed stream with the catalytic material in the reactor unit, for obtaining a product stream comprising H₂, N₂, NH₃, and optionally H₂O, wherein contacting is performed at a pressure in the range of from 1 to 100 bar(abs) and at a temperature in the range of from 50 to 750° C.;
(iii) optionally separating H₂O in the product stream obtained in (ii) for obtaining a dehydrated product stream comprising H₂, N₂, and NH₃;
(iv) separating NH₃ from the product stream obtained in (ii) or from the dehydrated product stream obtained in (iii) for obtaining a purified product stream comprising N₂ and H₂;
(v) recycling the separated NH₃ obtained in (iv) to (i).

It is preferred that from 90 to 100 volume-%, more preferably from 93 to 100 volume-%, more preferably from 95 to 100 volume-%, of the feed stream according to (i) consist of NH₃.

It is preferred that feeding the feed stream into the reactor unit according to (i) is performed at a gas hourly space velocity in the range of from 400 to 40,000 h⁻¹, more preferably in the range of from 2,000 to 12,000 h⁻¹.

It is preferred that feeding the feed stream into the reactor unit according to (i) is performed at a molar flow rate in the range of from 10 to 1000 kmol/h, more preferably in the range of from 100 to 700 kmol/h, more preferably in the range of from 140 to 660 kmol/h.

It is preferred that feeding the feed stream into the reactor unit according to (i) is performed at a mass flow rate in the range of from 100 to 25000 kg/h, more preferably in the range of from 1500 to 13000 kg/h, more preferably in the range of from 2400 to 11500 kg/h.

It is preferred that feeding the feed stream into the reactor unit according to (i) is performed at a volume flow rate in the range of from 250 to 55000 m³/h, more preferably in the range of from 5000 to 45000 m³/h, more preferably in the range of from 9250 to 41250 m³/h.

It is preferred that feeding the feed stream into the reactor unit according to (i) is performed at a volume flow rate in the range of from 50 to 2500 m³/h, more preferably in the range of from 250 to 1000 m³/h, more preferably in the range of from 400 to 725 m³/h.

It is preferred that the feed stream further comprises H₂O, wherein the feed stream more preferably comprises from 0 to 1 volume-%, more preferably from 0 to 0.5 volume-%, more preferably from 0 to 0.21 volume-% of H₂O.

It is preferred that the feed stream further comprises H₂, wherein the feed stream more preferably comprises from 0 to 1 volume-%, more preferably from 0 to 0.1 volume-%, more preferably from 0 to 0.01 volume-% of H₂.

It is preferred that the feed stream further comprises N₂, wherein the feed stream more preferably comprises from 0 to 5 volume-%, preferably from 0 to 1 volume-%, more preferably from 0 to 0.5 volume-% of N₂.

It is preferred that contacting according to (ii) is performed at a pressure in the range of from 5 to 55 bar(abs), more preferably in the range of from 10 to 50 bar(abs), more preferably in the range of from 15 to 45 bar(abs), more preferably in the range of from 20 to 40, more preferably in the range of from 25 to 35, more preferably in the range of from 27 to 33, more preferably in the range of from 29 to 31 bar(abs).

It is preferred that contacting according to (ii) is performed at a temperature in the range from 100 to 750° C., more preferably in the range from 160 to 650° C., more preferably in the range from 170 to 580° C., more preferably in the range from 180 to 570° C., more preferably in the range from 190 to 560° C., more preferably in the range from 200 to 550° C., more preferably in the range from 210 to 540° C., more preferably in the range from 220 to 530° C., more preferably in the range from 230 to 520° C., more preferably in the range from 240 to 510° C., more preferably in the range from 250 to 500° C.

It is preferred that contacting according to (ii) comprises increasing the temperature from the reactor unit inlet to the reactor unit outlet.

In case where contacting according to (ii) comprises increasing the temperature from the reactor unit inlet to the reactor unit outlet, it is preferred that the temperature is increased from 175° C., more preferably from 200° C., more preferably from 225° C., at the reactor unit inlet, to 350° C., preferably to 375° C., more preferably to 400° C., at the reactor unit outlet. Alternatively, it is further preferred that the temperature is increased from 375° C., more preferably from 400° C., more preferably from 425° C., at the reactor unit inlet, to 550° C., preferably to 575° C., more preferably to 600° C., at the reactor unit outlet.

According to the present invention it is preferred that contacting according to (ii) comprises transferring heat from a reaction of a chemical conversion process, wherein transferring heat is conducted using a heat exchanger or a heat pump.

In case where contacting according to (ii) comprises transferring heat from a reaction of a chemical conversion process, wherein transferring heat is conducted using a heat exchanger or a heat pump, it is preferred that the heat which is transferred is obtained from an exothermic reaction or wherein the heat which is transferred is excess heat of the heat employed for performing an autothermal reaction or an endothermic reaction.

In case where the heat which is transferred is obtained from an exothermic reaction, it is preferred that the exothermic reaction comprises one or more of methanol production, dimethyl ether production, NH₃ production, ethylene epoxidation, sulfuric acid production, and selective oxidation of one or more of alkanes, alkenes and alkynes, more preferably selective oxidation of one or more of alkanes, alkenes and alkynes to acrolein or acrylic acid.

In case where the heat which is transferred is excess heat of the heat employed for performing an endothermic reaction, it is preferred that the endothermic reaction comprises one or more of steam cracking, ethane dehydrogenation, propane dehydrogenation, butane dehydrogenation, steam reforming, dry reforming, styrene production, methanol reforming, dimethyl ether reforming, reverse water-gas shift, alcohol dehydration, and NH₃ reforming.

In case where the heat which is transferred is excess heat of the heat employed for performing an autothermal reaction, it is preferred that the autothermal reaction is selected from the group consisting of autothermal reforming of natural gas and hydrocarbons, including partial oxidation (POx) processes of hydrocarbons, wherein the hydrocarbons are selected from the group consisting of (C₁-C₁₀)alkanes, more preferably (C₁-C₅)alkanes, more preferably (C₁-C₇)alkanes.

According to the present invention, it is preferred that the reactor unit comprises one or more reactors, wherein the catalytic material is comprised in the one or more reactors.

In case where the reactor unit comprises one or more reactors, wherein the catalytic material is comprised in the one or more reactors, it is preferred that each of the one or more reactors independently from one another is selected from the group consisting of a polytropic reactor, a two-stage reactor, an adiabatic reactor and a combination of a polytropic and an adiabatic reactor.

Furthermore, it is preferred that each of the one or more reactors independently from one another is tubular, wherein a tubular reactor preferably comprises, more preferably consists of, 1 to 15,000 tubes, more preferably 100 to 12,000 tubes, and more preferably 500 to 5,000 tubes, wherein each one of the tubes independently from one another more preferably has a diameter in the range of from 1 to 50 cm, more preferably in the range of from 5 to 25 cm, more preferably in the range of from 8 to 22 cm.

Furthermore, it is preferred that each of the one or more reactors independently from one another has a length in the range of from 1 to 15, more preferably in the range of from 2 to 12 m, more preferably in the range of from 3 to 9 m.

Furthermore, it is preferred that each of the one or more reactors independently from one another has a diameter in the range of from 0.5 to 12 m, more preferably in the range of from 0.5 to 4 m, more preferably in the range of from 1.0 to 3.0 m, more preferably in the range of from 1.5 to 2.5 m.

Furthermore, it is preferred that each of the one or more reactors independently from one another has a volume in the range of from 0.5 to 150 m³, more preferably in the range of from 1 to 80 m³, more preferably in the range of from 2 to 50 m³, more preferably in the range of from 3 to 30 m³, more preferably in the range of from 4 to 20 m³, more preferably in the range of from 5.0 to 16.5 m³.

Furthermore and independently thereof, it is preferred that the reactor unit comprises, preferably consists of, one reactor, wherein the reactor unit inlet is the reactor inlet and wherein the reactor unit outlet is the reactor outlet.

It is further preferred that the reactor unit comprises, more preferably consists of, two or more reactors, preferably two adiabatic reactors, the two reactors being a first reactor and a second reactor, wherein the first reactor is arranged upstream of the second reactor, wherein the first reactor has a first reactor inlet and a first reactor outlet, wherein the reactor unit inlet is the first reactor inlet and wherein the reactor unit outlet is the second reactor outlet, wherein feeding according to (i) and contacting according to (ii) comprises
(i.1) feeding the feed stream comprising NH₃ into the first reactor, for obtaining an intermediate stream;
(ii.1) contacting the feed stream with the catalytic material in the first reactor, wherein contacting is performed at a pressure in the range of from 1 to 100 bar(abs) and at a temperature in the range of from 50 to 750° C.;
(i.2) feeding the intermediate stream obtained in (i.1) into the second reactor;
(ii.2) contacting the intermediate stream with the catalytic material in the second reactor, wherein contacting is performed at a pressure in the range of from 1 to 100 bar(abs) and at a temperature in the range of from 50 to 700° C.;
for obtaining the product stream comprising H₂, N₂, NH₃, and optionally H₂O.

In case where the reactor unit comprises two or more reactors, it is preferred that the catalytic material is comprised by one or both of the two reactors, wherein the catalytic material is more preferably comprised by the first reactor and the second reactor.

Furthermore and independently thereof, it is preferred that feeding the intermediate stream into the second reactor according to (i.2) is performed at a pressure in the range of from 1 to 100 bar(abs), more preferably in the range of from 5 to 50 bar(abs).

Furthermore and independently thereof, it is preferred that feeding the intermediate stream into the second reactor according to (i.2) is performed at a temperature in the range of from 250 to 650° C., more preferably in the range of from 400 to 600° C.

Furthermore and independently thereof, it is preferred that feeding the intermediate stream into the second reactor according to (i.2) is performed at the same pressure and at the same temperature as feeding the feed stream into the first reactor according to (i.1).

Furthermore and independently thereof, it is preferred that contacting according to one or both of (ii.1) and (ii.2) is performed at a pressure in the range of from 5 to 80 bar(abs), more preferably in the range of from 10 to 60 bar(abs), more preferably in the range of from 15 to 45 bar(abs), more preferably in the range of from 20 to 40, more preferably in the range of from 25 to 35, more preferably in the range of from 27 to 33, more preferably in the range of from 29 to 31 bar(abs).

Furthermore and independently thereof, it is preferred that contacting according to one or both of (ii.1) and (ii.2) is performed at a temperature in the range of from 100 to 750° C., more preferably in the range of from 160 to 650° C., more preferably in the range of from 170 to 580° C., more preferably in the range of from 180 to 570° C., more preferably in the range of from 190 to 560° C., more preferably in the range of from 200 to 550° C., more preferably in the range of from 210 to 540° C., more preferably in the range of from 220 to 530° C., more preferably in the range of from 230 to 520° C., more preferably in the range of from 240 to 510° C., more preferably in the range of from 250 to 500° C.

Furthermore and independently thereof, it is preferred that contacting according to one or both of (ii.1) and (ii.2) comprises increasing the temperature from the reactor inlet to the reactor outlet.

In case where contacting according to one or both of (ii.1) and (ii.2) comprises increasing the temperature from the reactor inlet to the reactor outlet, it is preferred that the temperature is increased from 175° C., more preferably from 200° C., more preferably from 225° C., at the reactor inlet, to 350° C., preferably to 375° C., more preferably to 400° C., at the reactor outlet. Alternatively, it is also preferred that the temperature is increased from 375° C., more preferably from 400° C., more preferably from 425° C., at the reactor inlet, to 550° C., preferably to 575° C., more preferably to 600° C., at the reactor outlet.

Furthermore and independently thereof, it is preferred that contacting according to one or both of (ii.1) and (ii.2) comprises transferring heat from a reaction of a chemical conversion process, wherein transferring heat is conducted using a heat exchanger or a heat pump.

In case where contacting according to one or both of (ii.1) and (ii.2) comprises transferring heat from a reaction of a chemical conversion process, wherein transferring heat is conducted using a heat exchanger or a heat pump, it is preferred that the heat which is transferred is obtained from an exothermic reaction or wherein the heat which is transferred is excess heat of the heat employed for performing an autothermal reaction or an endothermic reaction.

In case where the heat which is transferred is obtained from an exothermic reaction, it is preferred that the exothermic reaction comprises one or more of methanol production, dimethyl ether production, NH₃ production, ethylene epoxidation, sulfuric acid production, and selective oxidation of one or more of alkanes, alkenes and alkynes, more preferably selective oxidation of one or more of alkanes, alkenes and alkynes to acrolein or acrylic acid.

In case where the heat which is transferred is excess heat of the heat employed for performing an endothermic reaction, it is preferred that the endothermic reaction comprises one or more of steam cracking, ethane dehydrogenation, propane dehydrogenation, butane dehydrogenation, steam reforming, dry reforming, styrene production, methanol reforming, dimethyl ether reforming, reverse water-gas shift, alcohol dehydration, and NH₃ reforming.

In case where the heat which is transferred is excess heat of the heat employed for performing an autothermal reaction, it is preferred that the autothermal reaction is selected from the group consisting of autothermal reforming of natural gas and hydrocarbons, including partial oxidation (POx) processes of hydrocarbons, wherein the hydrocarbons are selected from the group consisting of (C₁-C₁₀)alkanes, more preferably (C₁-C₅)alkanes, more preferably (C₁-C₇)alkanes.

Furthermore and independently thereof, it is preferred that the reactor unit comprises two or more reactors, wherein the reactor unit further comprises one or more heaters, wherein a heater is arranged between two reactors.

In case where the reactor unit comprises two or more reactors, it is preferred that the reactor unit comprises two reactors, wherein the reactor unit further comprises one heater, wherein the heater is arranged downstream of the first reactor and upstream of the second reactor, for heating the intermediate stream.

According to the present invention, it is preferred that the reactor unit comprises one or more reactors, wherein the catalytic material is comprised by one or more of the one or more reactors.

It is preferred that the catalytic material comprises a metal M1, wherein M1 is Ni, Co, or Ni and Co.

In case where the catalytic material comprises a metal M1, wherein M1 is Ni, Co, or Ni and Co, it is preferred that the catalytic material further comprises a metal M2 selected from the group consisting of alkali metals, alkaline earth metals, Mo, Fe, Ru, including mixtures of two or more thereof, more preferably from the group consisting of Li, K, Na, Cs, Mg, Ca, Sr, Ba, Mo, Fe, Ru, including mixtures of two or more thereof, more preferably from the group consisting of K, Na, Cs, Ba, Mo, Fe, Ru, including mixtures of two or more thereof, more preferably from the group consisting of K, Ba, Mo, Fe, Ru, and mixtures of two or more thereof, wherein M2 more preferably comprises Fe, Ru, or Fe and Ru, wherein more preferably M2 comprises Ru, wherein more preferably M2 is Ru.

Furthermore and independently thereof, it is preferred that the catalytic material further comprises one or more support materials onto which the metal M1 or the metals M1 and M2 are supported, wherein the one or more support materials are more preferably selected from the group consisting of Al₂O₃, SiO₂, ZrO₂, CeO₂, MgO, CaO, and mixtures of two or more thereof, more preferably from the group consisting of Al₂O₃, SiO₂, ZrO₂, CeO₂, and mixtures of two or more thereof, more preferably from the group consisting of Al₂O₃, SiO₂, and a mixture thereof, wherein more preferably the support material comprises Al₂O₃.

Furthermore and independently thereof, it is preferred that the catalytic material displays an M2: M1 atomic ratio in the range of from 0.1:99.9 to 80:20, more preferably of from 0.5:99.5 to 75:25, more preferably of from 1:99 to 70:30, more preferably of from 5:95 to 65:35, more preferably of from 15:85 to 60:40, more preferably of from 30:70 to 55:45, and more preferably of from 40:60 to 50:50.

Furthermore and independently thereof, it is preferred that M2 comprises, more preferably is, Fe, and wherein the catalytic material displays an M2: M1 atomic ratio in the range of from 1:99 to 80:20, more preferably of from 5:95 to 75:25, more preferably of from 10:90 to 70:30, more preferably of from 20:80 to 65:35, more preferably of from 30:70 to 60:40, more preferably of from 35:65 to 55:45, and more preferably of from 40:60 to 50:50.

Furthermore and independently thereof, it is preferred that M2 comprises, more preferably is, Ru, and wherein the catalytic material displays an M2: M1 atomic ratio in the range of from 0.1:99.9 to 30:70, preferably of from 0.5:99.5 to 30:70, more preferably of from 1:99 to 20:80, more preferably of from 3:97 to 10:90, and more preferably of from 5:95 to 6:94.

Furthermore and independently thereof, it is preferred that the catalytic material further comprises Al and O.

In case where the catalytic material further comprises Al and O, it is preferred that the catalytic material comprises Ni as the metal M1, wherein more preferably the metal M1 is Ni.

In case where the catalytic material comprises Ni as the metal M1, it is preferred that the cata-lytic material further comprises Mg, wherein the Ni:Mg:Al molar ratio is more preferably in the range of from 1:(0.1-12):(0.5-20), more preferably of from 1:(0.5-8):(1-12), more preferably of from 1:(1-5):(3-8), more preferably of from 1:(1.5-3):(3.5-5), and more preferably of from 1:(2.0-2.4):(4.0-4.4).

Furthermore and independently thereof, it is preferred that from 95 to 100 wt.-% of the catalytic material consists of Ni, Mg, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Furthermore and independently thereof, it is preferred that from 95 to 100 wt.-% of the catalytic material consists of M2, Ni, Mg, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

In case where the catalytic material further comprises Al and O, it is preferred that the catalytic material comprises Co as the metal M1, wherein more preferably the metal M1 is Co.

In case where the catalytic material comprises Co as the metal M1, it is preferred that the cata-lytic material further comprises La, wherein the Co:La:Al molar ratio is more preferably in the range of from 1:(0.1-8):(1-50), more preferably of from 1:(0.5-5):(3-30), more preferably of from 1:(0.8-3):(5-20), more preferably of from 1:(1-2):(8-15), and more preferably of from 1:(1.3-1.7):(10-12).

Furthermore and independently thereof, it is preferred that from 95 to 100 wt.-% of the catalytic material consists of Co, La, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Furthermore and independently thereof, it is preferred that from 95 to 100 wt.-% of the catalytic material consists of M2, Co, La, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

According to the present invention, it is preferred that the catalytic material comprises Ru and one or more support materials, wherein Ru is supported on the one or more support materials, wherein the one or more support materials display a BET surface area of 20 m²/g or more, wherein the BET surface area is preferably determined according to ISO 9277:2010, and wherein the catalytic material contains 1 wt.-% or less of Ni and Co calculated as the respective element and based on 100 wt.-% of the catalytic material.

In case where the catalytic material comprises Ru and one or more support materials, it is preferred that the catalytic material contains 0.5 wt.-% or less of Ni and Co calculated as the respective element and based on 100 wt.-% of the catalytic material, more preferably 0.1 wt.-% or less, more preferably 0.05 wt.-% or less, more preferably 0.01 wt.-% or less, more preferably 0.005 wt.-% or less, and more preferably 0.001 wt.-% or less.

In case where the catalytic material comprises Ru and one or more support materials, it is also preferred that the reactor unit contains 1 wt.-% or less of Ni and Co calculated as the respective element and based on 100 wt.-% of the total contents of the reactor, more preferably 0.5 wt.-% or less, more preferably 0.1 wt.-% or less, more preferably 0.05 wt.-% or less, more preferably 0.01 wt.-% or less, more preferably 0.005 wt.-% or less, and more preferably 0.001 wt.-% or less.

Furthermore and independently thereof, it is preferred that the one or more support materials display a BET surface area in the range of from 30 to 800 m²/g, more preferably of from 40 to 500 m²/g, more preferably of from 50 to 300 m²/g, more preferably of from 60 to 200 m²/g, more preferably of from 70 to 100 m²/g, and more preferably of from 75 to 80 m²/g.

Furthermore and independently thereof, it is preferred that the one or more support materials display a BET surface area in the range of from greater than 20 to 150 m²/g, more preferably of from 21 to 100 m²/g, more preferably of from 22 to 70 m²/g, more preferably of from 23 to 50 m²/g, more preferably of from 24 to 40 m²/g, and more preferably of from 25 to 35 m²/g.

Furthermore and independently thereof, it is preferred that the one or more support materials display a pore volume in the range of from 0.2 to 3 ml/g, more preferably of from 0.4 to 1.5 ml/g, more preferably of from 0.6 to 1 ml/g, and more preferably of from 0.8 to 0.85 ml/g, wherein the pore volume is preferably determined according to ISO 15901-2:2022.

Furthermore and independently thereof, it is preferred that the catalytic material displays a BET surface area in the range of 20 to 800 m²/g, more preferably of from 30 to 500 m²/g, more preferably of from 40 to 300 m²/g, more preferably of from 50 to 200 m²/g, more preferably of from 60 to 100 m²/g, and more preferably of from 70 to 75 m²/g, wherein the BET surface area is preferably determined according to ISO 9277:2010.

Furthermore and independently thereof, it is preferred that the catalytic material displays a pore volume in the range of 0.1 to 2 ml/g, more preferably of from 0.15 to 1.2 ml/g, more preferably of from 0.2 to 0.8 ml/g, more preferably of from 0.25 to 0.5 ml/g, and more preferably of from 0.3 to 0.35 ml/g, wherein the pore volume is preferably determined according to ISO 15901-2:2022.

Furthermore and independently thereof, it is preferred that from 90 to 100 wt.-% of Ru calculated as the element, and based on 100 wt.-% of Ru contained in the catalytic material, is sup-ported on the one or more support materials comprised in the catalytic material, more preferably of from 95 to 100 wt.-%, more preferably of from 99 to 100 wt.-%, more preferably of from 99.5 to 100 wt.-%, and more preferably of from 99.9 to 100 wt.-%.

Furthermore and independently thereof, it is preferred that Ru is supported on the one or more support materials by an impregnation technique employing an aqueous solution of one or more ruthenium salts, wherein the one or more ruthenium salts more preferably comprise Ru(NO)(NO₃)₃, wherein more preferably Ru(NO)(NO₃)₃ is employed as the one or more ruthenium salts.

Furthermore and independently thereof, it is preferred that the one or more support materials are selected from the group consisting of metal oxides, wherein the metal of the metal oxides is preferably selected from the group consisting of Al, Si, Ti, Zr, Hf, V, Nb, Ta, Cr, Mo, W, Mn, alkaline earth metals, and rare earth metals, including combinations of two or more thereof, more preferably from the group consisting of Al, Si, Ti, Zr, Mg, Ca, La, Ce, Pr, and Nd, including combinations of two or more thereof, more preferably from the group consisting of Al, Ti, Zr, Mg, Ca, and La, including combinations of two or more thereof, more preferably from the group consisting of Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, wherein more preferably the one or more support materials comprise ZrO₂ and/or MgAl₂O₄, preferably ZrO₂, wherein more preferably the one or more support materials consist of ZrO₂ and/or MgAl₂O₄, preferably of ZrO₂.

In case where the one or more support materials comprise ZrO₂, it is preferred that the ZrO₂ comprises one or more crystalline phases and/or is amorphous, wherein the one or more crystalline phases of ZrO₂ are selected from the group consisting of the monoclinic, tetragonal, and cubic phases of ZrO₂, including mixtures of two or three thereof.

Furthermore and independently thereof, it is preferred that the one or more support materials contain substantially no CaO and/or MgO, more preferably substantially no CaO and MgO, more preferably substantially no alkaline earth metal oxide, more preferably substantially no Ca and/or Mg, more preferably substantially no Ca and Mg, and more preferably substantially no alkaline earth metal.

Furthermore and independently thereof, it is preferred that the one or more support materials contain substantially no Al₂O₃ and/or SiO₂, more preferably substantially no Al₂O₃ and SiO₂, more preferably substantially no Al and/or Si, and more preferably substantially no Al and Si. Furthermore and independently thereof, it is preferred that the one or more support materials contain substantially no carbon nanotubes, more preferably substantially no elemental carbon, and more preferably substantially no carbon.

Furthermore and independently thereof, it is preferred that the catalytic material comprises Ru in an amount in the range of from 0.5 to 15 wt.-% based on 100 wt.-% of the total amount of the one or more support materials, more preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.

Furthermore and independently thereof, it is preferred that from 95 to 100 wt.-% of the catalytic material consists of Ru and the one or more support materials, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Furthermore and independently thereof, it is preferred that the catalytic material further comprises one or more alkali metal and/or alkaline earth metal hydroxides, wherein the one or more alkali metal and/or alkaline earth metal hydroxides are supported on the one or more support materials supporting Ru, wherein the alkali metal and/or alkaline earth metal hydroxides are more preferably selected from the group consisting of Mg(OH)₂, Ca(OH)₂, Ba(OH)₂, Sr(OH)₂, LiOH, NaOH, and KOH, including mixtures of two or more thereof, more preferably from the group consisting of Mg(OH)₂, Ca(OH)₂, LiOH, NaOH, and KOH, including mixtures of two or more thereof, more preferably from the group consisting of LiOH, NaOH, and KOH, including mixtures of two or more thereof, wherein more preferably the catalytic material further comprises KOH and/or LiOH, preferably KOH.

In case where the catalytic material further comprises one or more alkali metal and/or alkaline earth metal hydroxides, it is preferred that the catalytic material comprises the one or more al-kali metal hydroxides in an amount in the range of from 0.5 to 15 wt.-% based on 100 wt.-% of the total amount of the one or more support materials, more preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.

Furthermore and independently thereof, it is preferred that from 95 to 100 wt.-% of the catalytic material consists of Ru, the one or more alkali metal hydroxides, and the one or more support materials, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Furthermore and independently thereof, it is preferred that the catalytic material is in the form of a molding and/or in powder form, more preferably in the form of a molding, and more preferably in the form of extrudates.

In case where the catalytic material is in the form of extrudates, it is preferred that the extrudates have a diameter in the range of from 0.5 to 10 mm, more preferably of from 1 to 7 mm, more preferably of from 1.5 to 5 mm, more preferably of from 2 to 4 mm, and more preferably of from 2.5 to 3.5 mm.

According to the present invention, it is yet further preferred that the catalytic material comprises Ni, Ru, and a promoter metal M1′, wherein the catalytic material displays an Ru: Ni weight ratio in the range of from 0.0001:1 to 0.5:1, wherein the promoter metal M1′ is selected from the group consisting of Li, K, Na, Cs, Mg, Ca, Sr, and Ba, including mixtures of two or more thereof, and wherein the catalytic material further comprises one or more support materials onto which Ni, Ru, and the promoter metal M1′ are respectively supported.

In case where the catalytic material comprises Ni, Ru, and a promoter metal M1′, it is preferred that the catalytic material displays an Ru: Ni weight ratio in the range of from 0.001:1 to 0.9:1, more preferably of from 0.005:1 to 0.5:1, more preferably of from 0.01:1 to 0.1:1, more preferably of from 0.02:1 to 0.05:1, and more preferably of from 0.025:1 to 0.035:1.

Furthermore and independently thereof, it is preferred that the promoter metal M1′ is selected from the group consisting of Li, K, Na, Cs, Mg, and Ca, including mixtures of two or more thereof, more preferably from the group consisting of Li, K, Na, and Cs, including mixtures of two or more thereof, more preferably from the group consisting of Li, K, and Na, including mixtures of two or more thereof, wherein more preferably the promoter metal M1′ is Li, K, or Li and K, wherein more preferably the promoter metal M1′ is K, wherein more preferably the promoter metal M1′ consists of Li, K, or Li and K, wherein more preferably the promoter metal M1′ consists of K.

Furthermore and independently thereof, it is preferred that the catalytic material displays an Ni: M1′ atomic ratio in the range of from 0.1:1 to 30:1, more preferably of from 0.5:1 to 20:1, more preferably of from 1:1 to 15:1, more preferably of from 1.5:1 to 10:1, more preferably of from 2:1 to 6:1, more preferably of from 2.5:1 to 4:1, more preferably of from 2.7:1 to 3.5:1, and more preferably of from 2.9:1 to 3:1.

Furthermore and independently thereof, it is preferred that the one or more support materials are selected from the group consisting of metal oxides, wherein the metal of the metal oxides is preferably selected from the group consisting of Al, Si, Ti, Zr, Hf, V, Nb, Ta, Cr, Mo, W, Mn, alkaline earth metals, and rare earth metals, including combinations of two or more thereof, more preferably from the group consisting of Al, Si, Ti, Zr, Mg, Ca, La, Ce, Pr, and Nd, including combinations of two or more thereof, more preferably from the group consisting of Al, Ti, Zr, Mg, Ca, and La, including combinations of two or more thereof, and more preferably from the group consisting of Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, more preferably from the group consisting of ZrO₂, NiMgO₂, and MgAl₂O₄, including mixtures of two or more thereof, wherein more preferably the one or more support materials comprise MgAl₂O₄, preferably NiMgO₂ and MgAl₂O₄, wherein more preferably the one or more support materials consist of MgAl₂O₄, or of NiMgO₂ and MgAl₂O₄, preferably of NiMgO₂ and MgAl₂O₄.

Furthermore and independently thereof, it is preferred that from 90 to 100 wt.-% of Ni and Ru calculated as the respective element, and based on 100 wt.-% of Ni and Ru contained in the catalytic material, is supported on the one or more support materials comprised in the catalytic material, more preferably of from 95 to 100 wt.-%, more preferably of from 99 to 100 wt.-%, more preferably of from 99.5 to 100 wt.-%, and more preferably of from 99.9 to 100 wt.-%.

Furthermore and independently thereof, it is preferred that from 90 to 100 wt.-% of Ni, Ru, and the promoter metal M1′, calculated as the respective element, and based on 100 wt.-% of Ni, Ru, and the promoter metal M1′ contained in the catalytic material, is supported on the one or more support materials comprised in the catalytic material, more preferably of from 95 to 100 wt.-%, more preferably of from 99 to 100 wt.-%, more preferably of from 99.5 to 100 wt.-%, and more preferably of from 99.9 to 100 wt.-%.

Furthermore and independently thereof, it is preferred that the catalytic material comprises Ni in an amount in the range of from 1 to 75 wt.-% calculated as the element and based on 100 wt.-% of the catalytic material, more preferably of from 3 to 60 wt.-%, more preferably of from 5 to 40 wt.-%, more preferably of from 10 to 25 wt.-%, more preferably of from 12 to 18 wt.-%, and more preferably of from 14 to 16 wt.-%.

Furthermore and independently thereof, it is preferred that the catalytic material comprises Ru in an amount in the range of from 0.01 to 5 wt.-% calculated as the element and based on 100 wt.-% of the catalytic material, more preferably of from 0.05 to 2.5 wt.-%, more preferably of from 0.1 to 1.5 wt.-%, more preferably of from 0.2 to 1 wt.-%, more preferably of from 0.3 to 0.8 wt.-%, and more preferably of from 0.4 to 0.6 wt.-%.

Furthermore and independently thereof, it is preferred that the catalytic material comprises the promoter metal M1′ in an amount in the range of from 0.05 to 25 wt.-% calculated as the element and based on 100 wt.-% of the catalytic material, more preferably of from 0.1 to 15 wt.-%, more preferably of from 0.5 to 10 wt.-%, more preferably of from 1 to 8 wt.-%, more preferably of from 2 to 5 wt.-%, and more preferably of from 3 to 4 wt.-%.

Furthermore and independently thereof, it is preferred that from 95 to 100 wt.-% of the catalytic material consists of Ni, Ru, the promoter metal M1′, and the one or more support materials, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%, wherein Ni, Ru, and the promoter metal M1′ may respectively be present as the element, as an oxide, and/or as a salt.

Furthermore and independently thereof, it is preferred that the catalytic material comprises the one or more promoter metal M1′ as a hydroxide, as a hydrogencarbonate, and/or as a carbonate, more preferably as a hydroxide and/or as a hydrogencarbonate, and more preferably as a hydroxide, wherein more preferably the promoter metal M1 is contained in the catalytic material as its hydroxide salt.

Furthermore and independently thereof, it is preferred that Ru is supported on the one or more support materials by an impregnation technique employing an aqueous solution of one or more ruthenium salts, wherein the one or more ruthenium salts more preferably comprise Ru(NO)(NO₃)₃, wherein more preferably Ru(NO)(NO₃)₃ is employed as the one or more ruthenium salts.

Furthermore and independently thereof, it is preferred that the catalytic material is in the form of a molding, in the form of extrudates, and/or in powder form, more preferably in the form of a molding or of extrudates, and more preferably in the form of a molding.

In case where the catalytic material is in the form of extrudates, it is preferred that the extrudates have a diameter in the range of from 0.5 to 10 mm, more preferably of from 1 to 7 mm, more preferably of from 1.5 to 5 mm, more preferably of from 2 to 4 mm, and more preferably of from 2.5 to 3.5 mm.

In case where the catalytic material is in the form of a molding, it is preferred that the molding has diameter in the range of 1 to 20 mm, more preferably in the range of 1 to 15 mm.

Furthermore and independently thereof, it is preferred that the molding is in the shape of a quadrilobe.

According to the present invention, it is preferred that separating according to (iii) is performed in a first separator, wherein the first separator is arranged downstream of the reactor unit.

It is preferred that separating according to (iii) comprises cooling the product stream to a temperature in the range of from 0 to 100° C., more preferably in the range of from 30 to 70° C., more preferably in the range of from 45 to 55° C.

It is preferred that separating according to (iii) comprises compressing the product stream to a pressure in the range of from 5 to 100 bar(abs), more preferably in the range of from 20 to 50 bar(abs), more preferably in the range of from 25 to 35 bar(abs).

It is preferred that separating according to (iv) is performed in a second separator, wherein the second separator is arranged downstream of the reactor unit or downstream of the first separator.

It is preferred that separating according to (iv) comprises heating the product stream or the dehydrated product stream to a temperature in the range of from −180 to 0° C., more preferably in the range of from −100 to −50° C., more preferably in the range of from −85 to −75° C. It is preferred that separating according to (iv) comprises compressing the product stream or the dehydrated product stream to a pressure in the range of from 10 to 100 bar(abs), more preferably in the range of from 35 to 65 bar(abs), more preferably in the range of from 45 to 55 bar(abs).

It is preferred that the process of the present invention further comprises after (iv) and prior to (v) heating the NH₃ obtained in (iv) to a temperature in the range of from 50 to 750° C., more preferably in the range of from 175 to 575° C., more preferably in the range of from 300 to 550° C.

It is also preferred that the process of the present invention further comprises after (iv) and prior to (v) expanding the NH₃ obtained in (iv) to a pressure in the range of from 1 to 50 bar(abs), more preferably in the range of from 1 to 35 bar(abs), more preferably in the range of from 1 to 30 bar(abs).

The unit bar(abs) refers to an absolute pressure wherein 1 bar equals 10⁵ Pa.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protection, but represents a suit-ably structured part of the description directed to general and preferred aspects of the present invention.
1. A process for NH₃ reforming, the process comprising
   (i) feeding a feed stream comprising NH₃ into a reactor unit, wherein the reactor unit has a reactor unit inlet and a reactor unit outlet, wherein the reactor unit comprises a catalytic material;
   (ii) contacting the feed stream with the catalytic material in the reactor unit, for obtaining a product stream comprising H₂, N₂, NH₃, and optionally H₂O, wherein contacting is performed at a pressure in the range of from 1 to 100 bar(abs) and at a temperature in the range of from 50 to 750° C.;
   (iii) optionally separating H₂O in the product stream obtained in (ii) for obtaining a dehydrated product stream comprising H₂, N₂, and NH₃;
   (iv) separating NH₃ from the product stream obtained in (ii) or from the dehydrated product stream obtained in (iii) for obtaining a purified product stream comprising N₂ and H₂;
   (v) recycling the separated NH₃ obtained in (iv) to (i).
2. The process of embodiment 1, wherein from 90 to 100 volume-%, preferably from 93 to 100 volume-%, more preferably from 95 to 100 volume-%, of the feed stream according to (i) consist of NH₃.
3. The process of embodiment 1 or 2, wherein feeding the feed stream into the reactor unit according to (i) is performed at a gas hourly space velocity in the range of from 400 to 40,000 h⁻¹, preferably in the range of from 2,000 to 12,000 h⁻¹.
4. The process of any one of embodiments 1 to 3, wherein feeding the feed stream into the reactor unit according to (i) is performed at a molar flow rate in the range of from 10 to 1000 kmol/h, preferably in the range of from 100 to 700 kmol/h, more preferably in the range of from 140 to 660 kmol/h.
5. The process of any one of embodiments 1 to 4, wherein feeding the feed stream into the reactor unit according to (i) is performed at a mass flow rate in the range of from 100 to 25000 kg/h, preferably in the range of from 1500 to 13000 kg/h, more preferably in the range of from 2400 to 11500 kg/h.
6. The process of any one of embodiments 1 to 5, wherein feeding the feed stream into the reactor unit according to (i) is performed at a volume flow rate in the range of from 250 to 55000 m³/h, preferably in the range of from 5000 to 45000 m³/h, more preferably in the range of from 9250 to 41250 m³/h.
7. The process of any one of embodiments 1 to 6, wherein feeding the feed stream into the reactor unit according to (i) is performed at a volume flow rate in the range of from 50 to 2500 m³/h, preferably in the range of from 250 to 1000 m³/h, more preferably in the range of from 400 to 725 m³/h.
8. The process of any one of embodiments 1 to 7, wherein the feed stream further comprises H₂O, wherein the feed stream preferably comprises from 0 to 1 volume-%, preferably from 0 to 0.5 volume-%, more preferably from 0 to 0.21 volume-% of H₂O.
9. The process of any one of embodiments 1 to 8, wherein the feed stream further comprises H₂, wherein the feed stream preferably comprises from 0 to 1 volume-%, more preferably from 0 to 0.1 volume-%, more preferably from 0 to 0.01 volume-% of H₂.
10. The process of any one of embodiments 1 to 9, wherein the feed stream further comprises N₂, wherein the feed stream preferably comprises from 0 to 5 volume-%, more preferably from 0 to 1 volume-%, more preferably from 0 to 0.5 volume-% of N₂.
11. The process of any one of embodiments 1 to 10, wherein contacting according to (ii) is performed at a pressure in the range of from 5 to 55 bar(abs), preferably in the range of from 10 to 50 bar(abs), more preferably in the range of from 15 to 45 bar(abs), more preferably in the range of from 20 to 40, more preferably in the range of from 25 to 35, more preferably in the range of from 27 to 33, more preferably in the range of from 29 to 31 bar(abs).
12. The process of any one of embodiments 1 to 11, wherein contacting according to (ii) is performed at a temperature in the range from 100 to 750° C., more preferably in the range from 160 to 650° C., more preferably in the range from 170 to 580° C., more preferably in the range from 180 to 570° C., more preferably in the range from 190 to 560° C., more preferably in the range from 200 to 550° C., more preferably in the range from 210 to 540° C., more preferably in the range from 220 to 530° C., more preferably in the range from 230 to 520° C., more preferably in the range from 240 to 510° C., more preferably in the range from 250 to 500° C.
13. The process of any one of embodiments 1 to 12, wherein contacting according to (ii) comprises increasing the temperature from the reactor unit inlet to the reactor unit outlet.
14. The process of embodiment 13, wherein the temperature is increased from 175° C., preferably from 200° C., more preferably from 225° C., at the reactor unit inlet, to 350° C., preferably to 375° C., more preferably to 400° C., at the reactor unit outlet.
15. The process of embodiment 13, wherein the temperature is increased from 375° C., preferably from 400° C., more preferably from 425° C., at the reactor unit inlet, to 550° C., preferably to 575° C., more preferably to 600° C., at the reactor unit outlet.
16. The process of any one of embodiments 1 to 15, wherein contacting according to (ii) comprises transferring heat from a reaction of a chemical conversion process, wherein transferring heat is conducted using a heat exchanger or a heat pump.
17. The process of embodiment 16, wherein the heat which is transferred is obtained from an exothermic reaction or wherein the heat which is transferred is excess heat of the heat employed for performing an autothermal reaction or an endothermic reaction.
18. The process of embodiment 17, wherein the exothermic reaction comprises one or more of methanol production, dimethyl ether production, NH₃ production, ethylene epoxidation, sulfuric acid production, and selective oxidation of one or more of alkanes, alkenes and alkynes, preferably selective oxidation of one or more of alkanes, alkenes and alkynes to acrolein or acrylic acid.
19. The process of embodiment 17, wherein the endothermic reaction comprises one or more of steam cracking, ethane dehydrogenation, propane dehydrogenation, butane dehydrogenation, steam reforming, dry reforming, styrene production, methanol reforming, dimethyl ether reforming, reverse water-gas shift, alcohol dehydration, and NH₃ reforming.
20. The process of embodiment 17, wherein the autothermal reaction is selected from the group consisting of autothermal reforming of natural gas and hydrocarbons, including partial oxidation (POx) processes of hydrocarbons, wherein the hydrocarbons are selected from the group consisting of (C₁-C₁₀)alkanes, more preferably (C₁-C₅)alkanes, more preferably (C₁-C₇)alkanes.
21. The process of any one of embodiments 1 to 20, wherein the reactor unit comprises one or more reactors, wherein the catalytic material is comprised in the one or more reactors.
22. The process of embodiment 21, wherein each of the one or more reactors independently from one another is selected from the group consisting of a polytropic reactor, a two-stage reactor, an adiabatic reactor and a combination of a polytropic and an adiabatic reactor.
23. The process of embodiment 21 or 22, wherein each of the one or more reactors independently from one another is tubular, wherein a tubular reactor preferably comprises, more preferably consists of, 1 to 15,000 tubes, more preferably 100 to 12,000 tubes, and more preferably 500 to 5,000 tubes, wherein each one of the tubes independently from one another more preferably has a diameter in the range of from 1 to 50 cm, more preferably in the range of from 5 to 25 cm, more preferably in the range of from 8 to 22 cm.
24. The process of any one of embodiments 21 to 23, wherein each of the one or more reactors independently from one another has a length in the range of from 1 to 15, more preferably in the range of from 2 to 12 m, more preferably in the range of from 3 to 9 m.
25. The process of any one of embodiments 21 to 24, wherein each of the one or more reactors independently from one another has a diameter in the range of from 0.5 to 12 m, preferably in the range of from 0.5 to 4 m, more preferably in the range of from 1.0 to 3.0 m, more preferably in the range of from 1.5 to 2.5 m.
26. The process of any one of embodiments 21 to 25, wherein each of the one or more reactors independently from one another has a volume in the range of from 0.5 to 150 m³, preferably in the range of from 1 to 80 m³, more preferably in the range of from 2 to 50 m³, more preferably in the range of from 3 to 30 m³, more preferably in the range of from 4 to 20 m³, more preferably in the range of from 5.0 to 16.5 m³.
27. The process of any one of embodiments 21 to 26, wherein the reactor unit comprises, preferably consists of, one reactor, wherein the reactor unit inlet is the reactor inlet and wherein the reactor unit outlet is the reactor outlet.
28. The process of any one of embodiments 21 to 26, wherein the reactor unit comprises, preferably consists of, two or more reactors, preferably two adiabatic reactors, the two reactors being a first reactor and a second reactor, wherein the first reactor is arranged upstream of the second reactor, wherein the first reactor has a first reactor inlet and a first reactor outlet, wherein the reactor unit inlet is the first reactor inlet and wherein the reactor unit outlet is the second reactor outlet, wherein feeding according to (i) and contacting according to (ii) comprises
   (i.1) feeding the feed stream comprising NH₃ into the first reactor, for obtaining an intermediate stream;
   (ii.1) contacting the feed stream with the catalytic material in the first reactor, wherein contacting is performed at a pressure in the range of from 1 to 100 bar(abs) and at a temperature in the range of from 50 to 750° C.;
   (i.2) feeding the intermediate stream obtained in (i.1) into the second reactor;
   (ii.2) contacting the intermediate stream with the catalytic material in the second reactor, wherein contacting is performed at a pressure in the range of from 1 to 100 bar(abs) and at a temperature in the range of from 50 to 700° C.;
for obtaining the product stream comprising H₂, N₂, NH₃, and optionally H₂O.
29. The process of embodiment 28, wherein the catalytic material is comprised by one or both of the two reactors, wherein the catalytic material is preferably comprised by the first reactor and the second reactor.
30. The process of embodiment 28 or 29, wherein feeding the intermediate stream into the second reactor according to (i.2) is performed at a pressure in the range of from 1 to 100 bar(abs), preferably in the range of from 5 to 50 bar(abs).
31. The process of any of embodiments 28 to 30, wherein feeding the intermediate stream into the second reactor according to (i.2) is performed at a temperature in the range of from 250 to 650° C., preferably in the range of from 400 to 600° C.
32. The process of any one of embodiments 28 to 31, wherein feeding the intermediate stream into the second reactor according to (i.2) is performed at the same pressure and at the same temperature as feeding the feed stream into the first reactor according to (i.1).
33. The process of any one of embodiments 28 to 32, wherein contacting according to one or both of (ii.1) and (ii.2) is performed at a pressure in the range of from 5 to 80 bar(abs), preferably in the range of from 10 to 60 bar(abs), more preferably in the range of from 15 to 45 bar(abs), more preferably in the range of from 20 to 40, more preferably in the range of from 25 to 35, more preferably in the range of from 27 to 33, more preferably in the range of from 29 to 31 bar(abs).
34. The process of any one of embodiments 28 to 33, wherein contacting according to one or both of (ii.1) and (ii.2) is performed at a temperature in the range of from 100 to 750° C., more preferably in the range of from 160 to 650° C., more preferably in the range of from 170 to 580° C., more preferably in the range of from 180 to 570° C., more preferably in the range of from 190 to 560° C., more preferably in the range of from 200 to 550° C., more preferably in the range of from 210 to 540° C., more preferably in the range of from 220 to 530° C., more preferably in the range of from 230 to 520° C., more preferably in the range of from 240 to 510° C., more preferably in the range of from 250 to 500° C.
35. The process of any one of embodiments 28 to 34, wherein contacting according to one or both of (ii.1) and (ii.2) comprises increasing the temperature from the reactor inlet to the reactor outlet.
36. The process of embodiment 35, wherein the temperature is increased from 175° C., preferably from 200° C., more preferably from 225° C., at the reactor inlet, to 350° C., preferably to 375° C., more preferably to 400° C., at the reactor outlet.
37. The process of embodiment 35, wherein the temperature is increased from 375° C., preferably from 400° C., more preferably from 425° C., at the reactor inlet, to 550° C., preferably to 575° C., more preferably to 600° C., at the reactor outlet.
38. The process of any one of embodiments 28 to 37, wherein contacting according to one or both of (ii.1) and (ii.2) comprises transferring heat from a reaction of a chemical conversion process, wherein transferring heat is conducted using a heat exchanger or a heat pump.
39. The process of embodiment 38, wherein the heat which is transferred is obtained from an exothermic reaction or wherein the heat which is transferred is excess heat of the heat employed for performing an autothermal reaction or an endothermic reaction.
40. The process of embodiment 39, wherein the exothermic reaction comprises one or more of methanol production, dimethyl ether production, NH₃ production, ethylene epoxidation, sulfuric acid production, and selective oxidation of one or more of alkanes, alkenes and alkynes, preferably selective oxidation of one or more of alkanes, alkenes and alkynes to acrolein or acrylic acid.
41. The process of embodiment 39, wherein the endothermic reaction comprises one or more of steam cracking, ethane dehydrogenation, propane dehydrogenation, butane dehydrogenation, steam reforming, dry reforming, styrene production, methanol reforming, dimethyl ether reforming, reverse water-gas shift, alcohol dehydration, and NH₃ reforming.
42. The process of embodiment 39, wherein the autothermal reaction is selected from the group consisting of autothermal reforming of natural gas and hydrocarbons, including partial oxidation (POx) processes of hydrocarbons, wherein the hydrocarbons are selected from the group consisting of (C₁-C₁₀)alkanes, more preferably (C₁-C₅)alkanes, more preferably (C₁-C₇)alkanes.
43. The process of any one of embodiments 28 to 42, preferably of embodiment 42, wherein the reactor unit comprises two or more reactors, wherein the reactor unit further comprises one or more heaters, wherein a heater is arranged between two reactors.
44. The process of embodiment 43, wherein the reactor unit comprises two reactors, wherein the reactor unit further comprises one heater, wherein the heater is arranged downstream of the first reactor and upstream of the second reactor, for heating the intermediate stream.
45. The process of any one of embodiments 1 to 44, wherein the reactor unit comprises one or more reactors, and wherein the catalytic material is comprised by one or more of the one or more reactors.
46. The process of any one of embodiments 1 to 45, wherein the catalytic material comprises a metal M1, wherein M1 is Ni, Co, or Ni and Co.
47. The process of embodiment 46, wherein the catalytic material further comprises a metal M2 selected from the group consisting of alkali metals, alkaline earth metals, Mo, Fe, Ru, including mixtures of two or more thereof, preferably from the group consisting of Li, K, Na, Cs, Mg, Ca, Sr, Ba, Mo, Fe, Ru, including mixtures of two or more thereof, more preferably from the group consisting of K, Na, Cs, Ba, Mo, Fe, Ru, including mixtures of two or more thereof, more preferably from the group consisting of K, Ba, Mo, Fe, Ru, and mixtures of two or more thereof, wherein M2 more preferably comprises Fe, Ru, or Fe and Ru, wherein more preferably M2 comprises Ru, wherein more preferably M2 is Ru.
48. The process of embodiment 46 or 47, wherein the catalytic material further comprises one or more support materials onto which the metal M1 or the metals M1 and M2 are sup-ported, wherein the one or more support materials are preferably selected from the group consisting of Al₂O₃, SiO₂, ZrO₂, CeO₂, MgO, CaO, and mixtures of two or more thereof, more preferably from the group consisting of Al₂O₃, SiO₂, ZrO₂, CeO₂, and mixtures of two or more thereof, more preferably from the group consisting of Al₂O₃, SiO₂, and a mixture thereof, wherein more preferably the support material comprises Al₂O₃.
49. The process of any one of embodiments 47 or 48, wherein the catalytic material displays an M2: M1 atomic ratio in the range of from 0.1:99.9 to 80:20, preferably of from 0.5:99.5 to 75:25, more preferably of from 1:99 to 70:30, more preferably of from 5:95 to 65:35, more preferably of from 15:85 to 60:40, more preferably of from 30:70 to 55:45, and more preferably of from 40:60 to 50:50.
50. The process of any of embodiments 47 to 49, wherein M2 comprises, preferably is, Fe, and wherein the catalytic material displays an M2: M1 atomic ratio in the range of from 1:99 to 80:20, preferably of from 5:95 to 75:25, more preferably of from 10:90 to 70:30, more preferably of from 20:80 to 65:35, more preferably of from 30:70 to 60:40, more preferably of from 35:65 to 55:45, and more preferably of from 40:60 to 50:50.
51. The process of any of embodiments 47 to 50, wherein M2 comprises, preferably is, Ru, and wherein the catalytic material displays an M2: M1 atomic ratio in the range of from 0.1:99.9 to 30:70, preferably of from 0.5:99.5 to 30:70, more preferably of from 1:99 to 20:80, more preferably of from 3:97 to 10:90, and more preferably of from 5:95 to 6:94.
52. The process of any one of embodiments 46 to 51, wherein the catalytic material further comprises Al and O.
53. The process of embodiment 52, wherein the catalytic material comprises Ni as the metal M1, wherein preferably the metal M1 is Ni.
54. The process of embodiment 53, wherein the catalytic material further comprises Mg, wherein the Ni:Mg:Al molar ratio is preferably in the range of from 1:(0.1-12):(0.5-20), more preferably of from 1:(0.5-8):(1-12), more preferably of from 1:(1-5):(3-8), more preferably of from 1:(1.5-3):(3.5-5), and more preferably of from 1:(2.0-2.4):(4.0-4.4).
55. The process of embodiment 53 or 54, wherein from 95 to 100 wt.-% of the catalytic material consists of Ni, Mg, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
56. The process of embodiment 53 or 54, wherein from 95 to 100 wt.-% of the catalytic material consists of M2, Ni, Mg, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
57. The process of embodiment 52, wherein the catalytic material comprises Co as the metal M1, wherein preferably the metal M1 is Co.
58. The process of embodiment 57, wherein the catalytic material further comprises La, wherein the Co:La:Al molar ratio is preferably in the range of from 1:(0.1-8):(1-50), more preferably of from 1:(0.5-5):(3-30), more preferably of from 1:(0.8-3):(5-20), more preferably of from 1:(1-2):(8-15), and more preferably of from 1:(1.3-1.7):(10-12).
59. The process of embodiment 57 or 58, wherein from 95 to 100 wt.-% of the catalytic material consists of Co, La, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
60. The process of embodiment 58 or 59, wherein from 95 to 100 wt.-% of the catalytic material consists of M2, Co, La, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
61. The process of any one of embodiments 1 to 45, wherein the catalytic material comprises Ru and one or more support materials, wherein Ru is supported on the one or more support materials, wherein the one or more support materials display a BET surface area of 20 m²/g or more, wherein the BET surface area is preferably determined according to ISO 9277:2010, and wherein the catalytic material contains 1 wt.-% or less of Ni and Co calculated as the respective element and based on 100 wt.-% of the catalytic material.
62. The process of embodiment 61, wherein the catalytic material contains 0.5 wt.-% or less of Ni and Co calculated as the respective element and based on 100 wt.-% of the catalytic material, preferably 0.1 wt.-% or less, more preferably 0.05 wt.-% or less, more preferably 0.01 wt.-% or less, more preferably 0.005 wt.-% or less, and more preferably 0.001 wt.-% or less.
63. The process of embodiment 61, wherein the reactor unit contains 1 wt.-% or less of Ni and Co calculated as the respective element and based on 100 wt.-% of the total contents of the reactor, preferably 0.5 wt.-% or less, more preferably 0.1 wt.-% or less, more preferably 0.05 wt.-% or less, more preferably 0.01 wt.-% or less, more preferably 0.005 wt.-% or less, and more preferably 0.001 wt.-% or less.
64. The process of any one of embodiments 61 to 63, wherein the one or more support materials display a BET surface area in the range of from 30 to 800 m²/g, preferably of from 40 to 500 m²/g, more preferably of from 50 to 300 m²/g, more preferably of from 60 to 200 m²/g, more preferably of from 70 to 100 m²/g, and more preferably of from 75 to 80 m²/g.
65. The process of any one of embodiments 61 to 64, wherein the one or more support materials display a BET surface area in the range of from greater than 20 to 150 m²/g, preferably of from 21 to 100 m²/g, more preferably of from 22 to 70 m²/g, more preferably of from 23 to 50 m²/g, more preferably of from 24 to 40 m²/g, and more preferably of from 25 to 35 m²/g.
66. The process of any one of embodiments 61 to 65, wherein the one or more support materials display a pore volume in the range of from 0.2 to 3 ml/g, preferably of from 0.4 to 1.5 ml/g, more preferably of from 0.6 to 1 ml/g, and more preferably of from 0.8 to 0.85 ml/g, wherein the pore volume is preferably determined according to ISO 15901-2:2022.
67. The process of any one of embodiments 61 to 66, wherein the catalytic material displays a BET surface area in the range of 20 to 800 m²/g, preferably of from 30 to 500 m²/g, more preferably of from 40 to 300 m²/g, more preferably of from 50 to 200 m²/g, more preferably of from 60 to 100 m²/g, and more preferably of from 70 to 75 m²/g, wherein the BET surface area is preferably determined according to ISO 9277:2010.
68. The process of any one of embodiments 61 to 67, wherein the catalytic material displays a pore volume in the range of 0.1 to 2 ml/g, preferably of from 0.15 to 1.2 ml/g, more preferably of from 0.2 to 0.8 ml/g, more preferably of from 0.25 to 0.5 ml/g, and more preferably of from 0.3 to 0.35 ml/g, wherein the pore volume is preferably determined according to ISO 15901-2:2022.
69. The process of any one of embodiments 61 to 68, wherein from 90 to 100 wt.-% of Ru calculated as the element, and based on 100 wt.-% of Ru contained in the catalytic material, is supported on the one or more support materials comprised in the catalytic material, preferably of from 95 to 100 wt.-%, more preferably of from 99 to 100 wt.-%, more preferably of from 99.5 to 100 wt.-%, and more preferably of from 99.9 to 100 wt.-%.
70. The process of any one of embodiments 61 to 69, wherein Ru is supported on the one or more support materials by an impregnation technique employing an aqueous solution of one or more ruthenium salts, wherein the one or more ruthenium salts preferably comprise Ru(NO)(NO₃)₃, wherein more preferably Ru(NO)(NO₃)₃ is employed as the one or more ruthenium salts.
71. The process of any one of embodiments 61 to 70, wherein the one or more support materials are selected from the group consisting of metal oxides, wherein the metal of the metal oxides is preferably selected from the group consisting of Al, Si, Ti, Zr, Hf, V, Nb, Ta, Cr, Mo, W, Mn, alkaline earth metals, and rare earth metals, including combinations of two or more thereof, more preferably from the group consisting of Al, Si, Ti, Zr, Mg, Ca, La, Ce, Pr, and Nd, including combinations of two or more thereof, more preferably from the group consisting of Al, Ti, Zr, Mg, Ca, and La, including combinations of two or more thereof, more preferably from the group consisting of Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, wherein more preferably the one or more support materials comprise ZrO₂ and/or MgAl₂O₄, preferably ZrO₂, wherein more preferably the one or more support materials consist of ZrO₂ and/or MgAl₂O₄, preferably of ZrO₂.
72. The process of embodiment 71, wherein the ZrO₂ comprises one or more crystalline phases and/or is amorphous, wherein the one or more crystalline phases of ZrO₂ are selected from the group consisting of the monoclinic, tetragonal, and cubic phases of ZrO₂, including mixtures of two or three thereof.
73. The process of any one of embodiments 61 to 72, wherein the one or more support materials contain substantially no CaO and/or MgO, preferably substantially no CaO and MgO, more preferably substantially no alkaline earth metal oxide, more preferably substantially no Ca and/or Mg, more preferably substantially no Ca and Mg, and more preferably substantially no alkaline earth metal.
74. The process of any one of embodiments 61 to 73, wherein the one or more support materials contain substantially no Al₂O₃ and/or SiO₂, preferably substantially no Al₂O₃ and SiO₂, more preferably substantially no Al and/or Si, and more preferably substantially no Al and Si.
75. The process of any one of embodiments 61 to 74, wherein the one or more support materials contain substantially no carbon nanotubes, preferably substantially no elemental carbon, and more preferably substantially no carbon.
76. The process of any one of embodiments 61 to 75, wherein the catalytic material comprises Ru in an amount in the range of from 0.5 to 15 wt.-% based on 100 wt.-% of the total amount of the one or more support materials, preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.
77. The process of any one of embodiments 61 to 76, wherein from 95 to 100 wt.-% of the catalytic material consists of Ru and the one or more support materials, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
78. The process of any one of embodiments 61 to 77, wherein the catalytic material further comprises one or more alkali metal and/or alkaline earth metal hydroxides, wherein the one or more alkali metal and/or alkaline earth metal hydroxides are supported on the one or more support materials supporting Ru, wherein the alkali metal and/or alkaline earth metal hydroxides are preferably selected from the group consisting of Mg(OH)₂, Ca(OH)₂, Ba(OH)₂, Sr(OH)₂, LiOH, NaOH, and KOH, including mixtures of two or more thereof, more preferably from the group consisting of Mg(OH)₂, Ca(OH)₂, LiOH, NaOH, and KOH, including mixtures of two or more thereof, more preferably from the group consisting of LiOH, NaOH, and KOH, including mixtures of two or more thereof, wherein more preferably the catalytic material further comprises KOH and/or LiOH, preferably KOH.
79. The process of embodiment 78, wherein the catalytic material comprises the one or more alkali metal hydroxides in an amount in the range of from 0.5 to 15 wt.-% based on 100 wt.-% of the total amount of the one or more support materials, preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.
80. The process of any one of embodiments 61 to 79, wherein from 95 to 100 wt.-% of the catalytic material consists of Ru, the one or more alkali metal hydroxides, and the one or more support materials, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
81. The process of any one of embodiments 61 to 80, wherein the catalytic material is in the form of a molding and/or in powder form, preferably in the form of a molding, and more preferably in the form of extrudates.
82. The process of embodiment 81, wherein the extrudates have a diameter in the range of from 0.5 to 10 mm, preferably of from 1 to 7 mm, more preferably of from 1.5 to 5 mm, more preferably of from 2 to 4 mm, and more preferably of from 2.5 to 3.5 mm.
83. The process of any one of embodiments 1 to 45, wherein the catalytic material comprises Ni, Ru, and a promoter metal M1′, wherein the catalytic material displays an Ru: Ni weight ratio in the range of from 0.0001:1 to 0.5:1, wherein the promoter metal M1′ is selected from the group consisting of Li, K, Na, Cs, Mg, Ca, Sr, and Ba, including mixtures of two or more thereof, and wherein the catalytic material further comprises one or more support materials onto which Ni, Ru, and the promoter metal M1′ are respectively sup-ported.
84. The process of embodiment 83, wherein the catalytic material displays an Ru: Ni weight ratio in the range of from 0.001:1 to 0.9:1, preferably of from 0.005:1 to 0.5:1, more preferably of from 0.01:1 to 0.1:1, more preferably of from 0.02:1 to 0.05:1, and more preferably of from 0.025:1 to 0.035:1.
85. The process of embodiment 83 or 84, wherein the promoter metal M1′ is selected from the group consisting of Li, K, Na, Cs, Mg, and Ca, including mixtures of two or more thereof, preferably from the group consisting of Li, K, Na, and Cs, including mixtures of two or more thereof, more preferably from the group consisting of Li, K, and Na, including mixtures of two or more thereof, wherein more preferably the promoter metal M1′ is Li, K, or Li and K, wherein more preferably the promoter metal M1′ is K, wherein more preferably the promoter metal M1′ consists of Li, K, or Li and K, wherein more preferably the promoter metal M1′ consists of K.
86. The process of any one of embodiments 83 to 85, wherein the catalytic material displays an Ni: M1′ atomic ratio in the range of from 0.1:1 to 30:1, preferably of from 0.5:1 to 20:1, more preferably of from 1:1 to 15:1, more preferably of from 1.5:1 to 10:1, more preferably of from 2:1 to 6:1, more preferably of from 2.5:1 to 4:1, more preferably of from 2.7:1 to 3.5:1, and more preferably of from 2.9:1 to 3:1.
87. The process of any one of embodiments 83 to 86, wherein the one or more support materials are selected from the group consisting of metal oxides, wherein the metal of the metal oxides is preferably selected from the group consisting of Al, Si, Ti, Zr, Hf, V, Nb, Ta, Cr, Mo, W, Mn, alkaline earth metals, and rare earth metals, including combinations of two or more thereof, more preferably from the group consisting of Al, Si, Ti, Zr, Mg, Ca, La, Ce, Pr, and Nd, including combinations of two or more thereof, more preferably from the group consisting of AI, Ti, Zr, Mg, Ca, and La, including combinations of two or more thereof, and more preferably from the group consisting of Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, more preferably from the group consisting of ZrO₂, NiMgO₂, and MgAl₂O₄, including mixtures of two or more thereof, wherein more preferably the one or more support materials comprise MgAl₂O₄, preferably NiMgO₂ and MgAl₂O₄, wherein more preferably the one or more support materials consist of MgAl₂O₄, or of NiMgO₂ and MgAl₂O₄, preferably of NiMgO₂ and MgAl₂O₄.
88. The process of any one of embodiments 83 to 87, wherein from 90 to 100 wt.-% of Ni and Ru calculated as the respective element, and based on 100 wt.-% of Ni and Ru contained in the catalytic material, is supported on the one or more support materials comprised in the catalytic material, preferably of from 95 to 100 wt.-%, more preferably of from 99 to 100 wt.-%, more preferably of from 99.5 to 100 wt.-%, and more preferably of from 99.9 to 100 wt.-%.
89. The process of any one of embodiments 83 to 88, wherein from 90 to 100 wt.-% of Ni, Ru, and the promoter metal M1′, calculated as the respective element, and based on 100 wt.-% of Ni, Ru, and the promoter metal M1′ contained in the catalytic material, is supported on the one or more support materials comprised in the catalytic material, preferably of from 95 to 100 wt.-%, more preferably of from 99 to 100 wt.-%, more preferably of from 99.5 to 100 wt.-%, and more preferably of from 99.9 to 100 wt.-%.
90. The process of any one of embodiments 83 to 89, wherein the catalytic material comprises Ni in an amount in the range of from 1 to 75 wt.-% calculated as the element and based on 100 wt.-% of the catalytic material, preferably of from 3 to 60 wt.-%, more preferably of from 5 to 40 wt.-%, more preferably of from 10 to 25 wt.-%, more preferably of from 12 to 18 wt.-%, and more preferably of from 14 to 16 wt.-%.
91. The process of any one of embodiments 83 to 90, wherein the catalytic material comprises Ru in an amount in the range of from 0.01 to 5 wt.-% calculated as the element and based on 100 wt.-% of the catalytic material, preferably of from 0.05 to 2.5 wt.-%, more preferably of from 0.1 to 1.5 wt.-%, more preferably of from 0.2 to 1 wt.-%, more preferably of from 0.3 to 0.8 wt.-%, and more preferably of from 0.4 to 0.6 wt.-%.
92. The process of any one of embodiments 83 to 91, wherein the catalytic material comprises the promoter metal M1′ in an amount in the range of from 0.05 to 25 wt.-% calculated as the element and based on 100 wt.-% of the catalytic material, preferably of from 0.1 to 15 wt.-%, more preferably of from 0.5 to 10 wt.-%, more preferably of from 1 to 8 wt.-%, more preferably of from 2 to 5 wt.-%, and more preferably of from 3 to 4 wt.-%.
93. The process of any one of embodiments 83 to 92, wherein from 95 to 100 wt.-% of the catalytic material consists of Ni, Ru, the promoter metal M1′, and the one or more support materials, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%, wherein Ni, Ru, and the promoter metal M1′ may respectively be present as the element, as an oxide, and/or as a salt.
94. The process of any one of embodiments 83 to 93, wherein the catalytic material comprises the one or more promoter metal M1′ as a hydroxide, as a hydrogencarbonate, and/or as a carbonate, preferably as a hydroxide and/or as a hydrogencarbonate, and more preferably as a hydroxide, wherein more preferably the promoter metal M1 is contained in the catalytic material as its hydroxide salt.
95. The process of any one of embodiments 83 to 94, wherein Ru is supported on the one or more support materials by an impregnation technique employing an aqueous solution of one or more ruthenium salts, wherein the one or more ruthenium salts preferably comprise Ru(NO)(NO₃)₃, wherein more preferably Ru(NO)(NO₃)₃ is employed as the one or more ruthenium salts.
96. The process of any one of embodiments 83 to 95, wherein the catalytic material is in the form of a molding, in the form of extrudates, and/or in powder form, preferably in the form of a molding or of extrudates, and more preferably in the form of a molding.
97. The process of embodiment 96, wherein the extrudates have a diameter in the range of from 0.5 to 10 mm, preferably of from 1 to 7 mm, more preferably of from 1.5 to 5 mm, more preferably of from 2 to 4 mm, and more preferably of from 2.5 to 3.5 mm.
98. The process of embodiment 96, wherein the molding has diameter in the range of 1 to 20 mm, preferably in the range of 1 to 15 mm.
99. The process of any one of embodiments 96 or 98, wherein the molding is in the shape of a quadrilobe.
100. The process of any one of embodiments 1 to 99, wherein separating according to (iii) is performed in a first separator, wherein the first separator is arranged downstream of the reactor unit.
101. The process of any one of embodiments 1 to 100, wherein separating according to (iii) comprises cooling the product stream to a temperature in the range of from 0 to 100° C., preferably in the range of from 30 to 70° C., more preferably in the range of from 45 to 55° C.
102. The process of any one of embodiments 1 to 101, wherein separating according to (iii) comprises compressing the product stream to a pressure in the range of from 5 to 100 bar(abs), preferably in the range of from 20 to 50 bar(abs), more preferably in the range of from 25 to 35 bar(abs).
103. The process of any one of embodiments 1 to 102, wherein separating according to (iv) is performed in a second separator, wherein the second separator is arranged downstream of the reactor unit or downstream of the first separator as defined in embodiment 101.
104. The process of any one of embodiments 1 to 103, wherein separating according to (iv) comprises heating the product stream or the dehydrated product stream to a temperature in the range of from −180 to 0° C., preferably in the range of from −100 to −50° C., more preferably in the range of from −85 to −75° C.
105. The process of any one of embodiments 1 to 104, wherein separating according to (iv) comprises compressing the product stream or the dehydrated product stream to a pressure in the range of from 10 to 100 bar(abs), preferably in the range of from 35 to 65 bar(abs), more preferably in the range of from 45 to 55 bar(abs).
106. The process of any one of embodiments 1 to 105, further comprising after (iv) and prior to (v) heating the NH₃ obtained in (iv) to a temperature in the range of from 50 to 750° C., preferably in the range of from 175 to 575° C., more preferably in the range of from 300 to 550° C.
107. The process of any one of embodiments 1 to 106, further comprising after (iv) and prior to (v) expanding the NH₃ obtained in (iv) to a pressure in the range of from 1 to 50 bar(abs), preferably in the range of from 1 to 35 bar(abs), more preferably in the range of from 1 to 30 bar(abs).

The present invention is further illustrated by the following reference examples, examples and comparative examples.

### EXAMPLES

The following examples were simulated with Aspen Plus software Version 12.

### Reference Example 1: Ru-Containing Catalytic Material

A low temperature active NH₃ reforming catalytic material was provided.

A catalyst comprising Ru(5 wt.-%) and KOH (5 wt.-%) supported on ZrO₂ was used. Said catalyst was prepared as follows. A 5 g sample of the 5 wt.-% Ru on ZrO₂ extrudates as obtained from example 1 was subject to impregnation with a KOH solution. To this effect, 5 g of the extrudates obtained from Example 1 were split to form fractions in the range of 315 to 500 microns, which was then impregnated via incipient wetness impregnation with 0.25 g of KOH dissolved in 1.65 ml of water. The sample was then dried at 120° C. and subsequently calcined under inert atmosphere at 500° C. for 2 hours. . . .

Further, a kinetic model was developed for the provided Ru-containing catalytic material, allowing a proper simulation of the conversion numbers considering the boundaries and concepts de-scribed herein (see Figure . . . ).

### Reference Example 2: Provision of a Feed Stream Comprising NH₃

For the simulations of a NH₃-reforming process with recycling, a reference scenario with about 10 t/h NH₃ as feed stream was defined. Further, the pressure and the temperature of the feed stream were set as indicated in the respective example. The feed stream comprising NH₃ consisted of 99 to 99.9 volume-% of NH₃ and 0.1 to 1 volume-% of H₂O.

### Example 1: Process for Reforming NH₃ in a Polytropic Reactor with Recycling of Unconverted NH₃

A reactor unit comprising a single, polytropic and heated reactor including the Ru-containing catalytic material according to Reference Example 1 was set. The reactor dimensions were fixed at 5 m of length and 2 m of diameter. A feed stream according to Reference Example 2 was provided. The reforming of NH₃ was simulated for said polytropic reactor at a pressure of 1 bar(abs) and an initial temperature of 250° C., which was increased along the reactor bed length to reach 350° C. at the outlet. The resultant conversion profile is shown in

FIG. 2 and the properties of the individual process streams are given in Tables 1a and 1b below, respectively.

TABLE 1a
Characteristics of the individual process streams, determined
for the simulation according to Example 1 (Part 1).

| | | Mixture | | |
|---|---|---|---|---|
| | | of feed | | Separation |
| | | stream and | Reactor | H₂O- |
| | Feed | recycle | outlet | containing |
| | stream | stream | stream | stream |
| | Phase | | | |
| | Gaseous | Gaseous | Gaseous | Liquid |
| Temperature | 250 | 250 | 350 | 50 |
| [° C.] | | | | |
| Pressure | 1 | 1 | 1 | 30 |
| [bar(abs)] | | | | |
| Mole Flows | 293.5309 | 655.8726 | 943.7335 | 5.1134 |
| [kmol/h] | | | | |
| Mole | | | | |
| Fractions X | | | | |
| X_NH₃ | 0.9949 | 0.9689 | 0.3683 | 0.7096 |
| X_H₂O | 5.00 · 10⁻³ | 0.0028 | 0.0019 | 0.287 |
| X_H₂ | 0.0001 | 0.0015 | 0.4586 | 0.0006 |
| X_N₂ | 0.0000 | 0.0268 | 0.1712 | 0.0028 |
| Mass Flows | 5000.0000 | 11350.3666 | 11350.3666 | 88.6380 |
| [kg/h] | | | | |
| Volume Flow | 12767.5423 | 28528.3657 | 48895.5393 | 0.1328 |
| [cum/h] | | | | |

TABLE 1b
Characteristics of the individual process streams, determined
for the simulation according to Example 1 (Part 2).

| | | Separation | | Heated |
|---|---|---|---|---|
| | H₂- and | H₂- | NH₃- | NH₃- |
| | NH₃- | containg | containing | containing |
| | containing | product | stream for | stream for |
| | stream | stream | recycling | recycling |
| | Phase | | | |
| | Gaseous | Gaseous | Liquid | Gaseous |
| Temperature | 50 | −80 | −80 | 250 |
| [° C.] | | | | |
| Pressure | 30 | 50 | 50 | 1 |
| [bar(abs)] | | | | |
| Mole Flows | 938.6201 | 576.2888 | 362.3314 | 362.3417 |
| [kmol/h] | | | | |
| Mole | | | | |
| Fractions X | | | | |
| X_NH₃ | 0.3665 | 0.0010 | 0.9478 | 0.9478 |
| X_H₂O | 3.85 · 10⁻⁴ | 6.99 · 10⁻¹⁴ | 9.97 · 10⁻⁴ | 9.96 · 10⁻⁴ |
| X_H₂ | 0.4611 | 0.7493 | 0.0026 | 0.0026 |
| X_N₂ | 0.1721 | 0.2497 | 0.0486 | 0.0486 |
| Mass Flows | 11261.7286 | 4911.5271 | 6350.2015 | 6350.3666 |
| [kg/h] | | | | |
| Volume Flow | 840.6206 | 185.0939 | 8.6408 | 15760.5260 |
| [cum/h] | | | | |

From the results shown in Tables 1a and 1b, a conversion of 60% can be determined at the reactor outlet under steady state recycle conditions. Residual NH₃ in the H₂-containing product stream was reduced to 1000 ppm in a separation step.

### Example 2: Process for Reforming NH₃ in a Polytropic Reactor with Recycling of Unconverted NH₃

A reactor unit comprising a single, polytropic and heated reactor including the Ru-containing catalytic material according to Reference Example 1, was set. The reactor dimensions were fixed at 5 m of length and 2 m of diameter. A feed stream according to Reference Example 2 was provided. The reforming of NH₃ was simulated for said polytropic reactor at a pressure of 1 bar(abs) and an initial temperature of 450° C., which was increased along the reactor bed length to reach 550° C. at the outlet. The resultant conversion profile is shown in

FIG. 3 and the properties of the individual process streams are given in Tables 2a and 2b below, respectively.

TABLE 2a
Characteristics of the individual process streams, determined
for the simulation according to Example 2 (Part 1).

| | | Mixture | | |
|---|---|---|---|---|
| | | of feed | | Separation |
| | | stream and | Reactor | H₂O- |
| | Feed | recycle | outlet | containing |
| | stream | stream | stream | stream |
| | Phase | | | |
| | Gaseous | Gaseous | Gaseous | Liquid |
| Temperature | 450 | 450 | 550 | 50 |
| [° C.] | | | | |
| Pressure | 1 | 1 | 1 | 30 |
| [bar(abs)] | | | | |
| Mole Flows | 528.3556 | 609.6799 | 1133.1845 | 3.8438 |
| [kmol/h] | | | | |
| Mole | | | | |
| Fractions X | | | | |
| X_NH₃ | 0.9949 | 0.9843 | 0.0676 | 0.3075 |
| X_H₂O | 5.00 · 10⁻³ | 0.0088 | 0.0047 | 0.687 |
| X_H₂ | 0.0001 | 0.0004 | 0.6932 | 0.0010 |
| X_N₂ | 0.0000 | 0.0065 | 0.2345 | 0.0042 |
| Mass Flows | 9000.0000 | 10427.9308 | 10427.9308 | 68.1803 |
| [kg/h] | | | | |
| Volume Flow | 31767.4219 | 36657.0490 | 77554.4770 | 0.0824 |
| [cum/h] | | | | |

TABLE 2b
Characteristics of the individual process streams, determined
for the simulation according to Example 2 (Part 2).

| | | Separation | | Heated |
|---|---|---|---|---|
| | H₂- and | H₂- | NH₃- | NH₃- |
| | NH₃- | containg | containing | containing |
| | containing | product | stream for | stream for |
| | stream | stream | recycling | recycling |
| | Phase | | | |
| | Gaseous | Gaseous | Liquid | Gaseous |
| Temperature | 50 | −80 | −80 | 450 |
| [° C.] | | | | |
| Pressure | 30 | 50 | 50 | 1 |
| [bar(abs)] | | | | |
| Mole Flows | 1129.3407 | 1048.0184 | 81.3224 | 81.3243 |
| [kmol/h] | | | | |
| Mole | | | | |
| Fractions X | | | | |
| X_NH₃ | 0.0668 | 0.0009 | 0.9154 | 0.9154 |
| X_H₂O | 2.40 · 10⁻³ | 2.39 · 10⁻¹² | 3.34 · 10⁻² | 3.34 · 10⁻² |
| X_H₂ | 0.6956 | 0.7493 | 0.0026 | 0.0026 |
| X_N₂ | 0.2353 | 0.2497 | 0.0486 | 0.0486 |
| Mass Flows | 10359.7505 | 8931.8531 | 1427.8975 | 1427.9308 |
| [kg/h] | | | | |
| Volume Flow | 1011.4284 | 336.6052 | 1.9183 | 4889.6274 |
| [cum/h] | | | | |

From the results shown in Tables 2a and 2b, a conversion of 92% can be determined at the reactor outlet under steady state recycle conditions. From the results, it can be gathered that the increase of the temperature profile is beneficial for the overall conversion. As a result, comparatively less NH₃ was available for recycling than according to the process of Example 1. Residual NH₃ in the H₂-containing product stream was reduced to 1000 ppm in a separation step.

### Example 3: Process for Reforming NH₃ in a Polytropic Reactor with Recycling of Unconverted NH₃

A reactor unit comprising a single, polytropic and heated reactor including the Ru-containing catalytic material according to Reference Example 1, was set. The reactor dimensions were fixed at 5 m of length and 2 m of diameter. A feed stream according to Reference Example 2 was provided. The reforming of NH₃ was simulated for said polytropic reactor at an elevated pressure of 30 bar(abs) and an initial temperature of 250° C., which was increased along the reactor bed length to reach 350° C. at the outlet. The resultant conversion profile is shown in

FIG. 4 and the properties of the individual process streams are given in Tables 3a and 3b below, respectively.

TABLE 3a
Characteristics of the individual process streams, determined
for the simulation according to Example 3 (Part 1).

| | | Mixture | | |
|---|---|---|---|---|
| | | of feed | | |
| | | stream and | Reactor | H₂O- |
| | Feed | recycle | outlet | containing |
| | stream | stream | stream | stream |
| | Phase | | | |
| | Gaseous | Gaseous | Gaseous | Liquid |
| Temperature[° C.] | 250 | 250 | 350 | 50 |
| Pressure | 30 | 30 | 30 | 30 |
| [bar(abs)] | | | | |
| Mole Flows | 293.5309 | 488.1617 | 529.3073 | 253.0475 |
| [kmol/h] | | | | |
| Mole | | | | |
| Fractions X | | | | |
| X_NH₃ | 0.9949 | 0.9770 | 0.8233 | 0.9911 |
| X_H₂O | 5.00 · 10⁻³ | 0.0030 | 0.0028 | 5.80 · 10⁻³ |
| X_H₂ | 0.0001 | 0.0011 | 0.1176 | 0.0005 |
| X_N₂ | 0.0000 | 0.0189 | 0.0563 | 0.0026 |
| Mass Flows | 5000.0000 | 8408.4488 | 8408.4488 | 4316.4820 |
| [kg/h] | | | | |
| Volume Flow | 425.5847 | 707.7693 | 914.1269 | 7.6813 |
| [cum/h] | | | | |

TABLE 3b
Characteristics of the individual process streams, determined
for the simulation according to Example 3 (Part 2).

| | | | | Heated NH₃- |
|---|---|---|---|---|
| | H₂- and NH₃- | H₂-containg | NH₃-containing | containing |
| | containing | product | stream for | stream for |
| | stream | stream | recycling | recycling |
| | Phase | | | |
| | Gaseous | Gaseous | Liquid | Gaseous |
| Temperature[° C.] | 50 | −80 | −80 | 250 |
| Pressure | 30 | 50 | 50 | 30 |
| [bar(abs)] | | | | |
| Mole Flows | 276.2598 | 81.6241 | 194.6357 | 194.6308 |
| [kmol/h] | | | | |
| Mole | | | | |
| Fractions X | | | | |
| X_NH₃ | 0.6696 | 0.0010 | 0.9499 | 0.9499 |
| X_H₂O | 1.46 · 10⁻⁶ | 1.45 · 10⁻¹⁶ | 2.07 · 10⁻⁶ | 2.07 · 10⁻⁶ |
| X_H₂ | 0.2249 | 0.7551 | 0.0026 | 0.0026 |
| X_N₂ | 0.1055 | 0.2440 | 0.0474 | 0.0474 |
| Mass Flows | 4091.9668 | 683.4405 | 3408.5262 | 3408.4488 |
| [kg/h] | | | | |
| Volume Flow | 247.4160 | 26.2162 | 4.6395 | 282.1921 |
| [cum/h] | | | | |

From the results shown in Table 3, a conversion of 15% can be determined at the reactor outlet under steady state recycle conditions.

### Example 4: Process for Reforming NH₃ in an Adiabatic Reactor with Recycling of Unconverted NH₃

A reactor unit comprising a single, adiabatic reactor including the Ru-containing catalytic material according to Reference Example 1, was set. The reactor dimensions were fixed at 5 m of length and 2 m of diameter. A feed stream according to Reference Example 2 was provided. The reforming of NH₃ was simulated for said polytropic reactor at a pressure of 1 bar(abs) and an initial temperature of 500° C. The resultant conversion profile is shown in

FIG. 5 and the properties of the individual process streams are given in Tables 4a and 4b below, respectively.

TABLE 4a
Characteristics of the individual process streams, determined
for the simulation according to Example 4 (Part 1).

| | | Mixture | | |
|---|---|---|---|---|
| | | of feed | | |
| | | stream and | Reactor | H₂O- |
| | Feed | recycle | outlet | containing |
| | stream | stream | stream | stream |
| | Phase | | | |
| | Gaseous | Gaseous | Gaseous | Liquid |
| Temperature | 500 | 500 | 267.1 | 50 |
| [° C.] | | | | |
| Pressure | 1 | 1 | 1 | 30 |
| [bar(abs)] | | | | |
| Mole Flows | 146.7654 | 639.2179 | 775.7474 | 9.9918 |
| [kmol/h] | | | | |
| Mole | | | | |
| Fractions X | | | | |
| X_NH₃ | 0.9949 | 0.9594 | 0.6145 | 0.9236 |
| X_H₂O | 5.00 · 10⁻³ | 0.0012 | 0.0010 | 7.34 · 10⁻² |
| X_H₂ | 0.0001 | 0.0020 | 0.2657 | 0.0005 |
| X_N₂ | 0.0000 | 0.0374 | 0.1188 | 0.0025 |
| Mass Flows | 2500.000 | 11130.1821 | 11130.1821 | 171.0956 |
| [kg/h] | | | | |
| Volume Flow | 9434.412 | 41090.314 | 34842.427 | 0.291 |
| [cum/h] | | | | |

TABLE 4b
Characteristics of the individual process streams, determined
for the simulation according to Example 4 (Part 2).

| | | | | Heated |
|---|---|---|---|---|
| | H₂- and | H₂- | NH₃- | NH₃- |
| | NH₃- | containg | containing | containing |
| | containing | product | stream for | stream for |
| | stream | stream | recycling | recycling |
| | Phase | | | |
| | Gaseous | Gaseous | Liquid | Gaseous |
| Temperature | 50 | −80 | −80 | 500 |
| [° C.] | | | | |
| Pressure | 30 | 50 | 50 | 1 |
| [bar(abs)] | | | | |
| Mole Flows | 765.7556 | 273.3087 | 492.4469 | 492.4525 |
| [kmol/h] | | | | |
| Mole | | | | |
| Fractions X | | | | |
| X_NH₃ | 0.6105 | 0.0010 | 0.9488 | 0.9488 |
| X_H₂O | 3.10 · 10⁻⁵ | 3.38 · 10⁻¹⁵ | 4.83 · 10⁻⁵ | 4.83 · 10⁻⁵ |
| X_H₂ | 0.2691 | 0.7494 | 0.0026 | 0.0026 |
| X_N₂ | 0.1203 | 0.2497 | 0.0486 | 0.0486 |
| Mass Flows | 10959.0865 | 2329.0105 | 8630.0760 | 8630.1821 |
| [kg/h] | | | | |
| Volume Flow | 685.805 | 87.782 | 11.747 | 31655.983 |
| [cum/h] | | | | |

From the results shown in Tables 4a and 4b, a conversion of 35% can be determined at the reactor outlet under steady state recycle conditions. Residual NH₃ in the H₂-containing product stream was reduced to 1000 ppm in a separation step.

### Example 5: Process for Reforming NH₃ in a Reactor Cascade Containing Two Adiabatic Reactors With Recycling of Unconverted NH₃

A reactor unit was set comprising two adiabatic reactors arranged in series, wherein a heater was arranged between the reactors for heating the outlet stream of the upstream reactor. Both of the reactors included the Ru-containing catalytic material according to Reference Example 1. Each reactor had a length of 5 m and a diameter of 2 m. A feed stream according to Reference Example 2 was provided. The reforming of NH₃ was simulated for said reactor cascade at a pressure of 1 bar(abs) and the initial temperature for each reactor was 500° C. The resultant conversion profile is shown in

FIG. 6 and the properties of the individual process streams are given in Tables 5a and 5b below, respectively.

TABLE 5a
Characteristics of the individual process streams, determined
for the simulation according to Example 5 (Part 1).

| | | Mixture of | | | |
|---|---|---|---|---|---|
| | | feed stream | | Heated | Reactor |
| | Feed | and recycle | Intermediate | intermediate | outlet |
| | stream | stream | stream | stream | stream |
| | Phase | | | | |
| | Gaseous | Gaseous | Gaseous | Gaseous | Gaseous |
| Temperature | 500 | 500 | 265.9 | 500 | 330 |
| [° C.] | | | | | |
| Pressure | 1 | 1 | 1 | 1 | 1 |
| [bar(abs)] | | | | | |
| Mole Flows | 234.8247 | 603.6876 | 733.6036 | 733.6036 | 833.1232 |
| [kmol/h] | | | | | |
| Mole | | | | | |
| Fractions X | | | | | |
| X_NH₃ | 0.9949 | 0.9664 | 0.6182 | 0.6182 | 0.4249 |
| X_H₂O | 0.0050 | 0.0023 | 0.0019 | 0.0019 | 0.0017 |
| X_H₂ | 0.0001 | 0.0016 | 0.2670 | 0.2670 | 0.4143 |
| X_N₂ | 0.0000 | 0.0297 | 0.1130 | 0.1130 | 0.1592 |
| Mass Flows | 4000.0000 | 10464.5132 | 10464.5132 | 10464.5132 | 10464.5132 |
| [kg/h] | | | | | |
| Volume Flow | 15095.0593 | 38806.4198 | 32880.0275 | 47157.6818 | 41772.0673 |
| [cum/h] | | | | | |

TABLE 5b
Characteristics of the individual process streams, determined
for the simulation according to Example 5 (Part 2).

| | | | | | Heated NH₃- |
|---|---|---|---|---|---|
| | | H₂- and NH₃- | H₂-containg | NH₃-containing | containing |
| | H₂O-containing | containing | product | stream for | stream for |
| | stream | stream | stream | recycling | recycling |
| | Phase | | | | |
| | Liquid | Gaseous | Gaseous | Liquid | Gaseous |
| Temperature | 50 | 50 | −80 | −80 | 500 |
| [° C.] | | | | | |
| Pressure | 30 | 30 | 50 | 50 | 1 |
| [bar(abs)] | | | | | |
| Mole Flows | 4.9380 | 828.1852 | 459.3220 | 368.8632 | 368.8629 |
| [kmol/h] | | | | | |
| Mole | | | | | |
| Fractions X | | | | | |
| X_NH₃ | 0.7590 | 0.4229 | 0.0010 | 0.9483 | 0.9483 |
| X_H₂O | 0.2378 | 2.58 · 10⁻⁴ | 4.06 · 10⁻¹⁴ | 5.79 · 10⁻⁴ | 5.79 · 10⁻⁴ |
| X_H₂ | 0.0006 | 0.4167 | 0.7493 | 0.0026 | 0.0026 |
| X_N₂ | 0.0027 | 0.1601 | 0.2497 | 0.0486 | 0.0486 |
| Mass Flows | 85.3561 | 10379.1571 | 3914.6375 | 6464.5195 | 6464.5132 |
| [kg/h] | | | | | |
| Volume Flow | 0.1315 | 741.7160 | 147.5262 | 8.7978 | 23711.3307 |
| [cum/h] | | | | | |

From the results shown in Tables 5a and 5b, a conversion of 54% can be obtained at the reactor unit outlet under steady state recycle conditions. In particular, the conversion after the first reactor was 35%, comparable with the conversion obtained according to Example 4. The residue of NH₃ in the H₂-containing product stream was reduced to 1000 ppm in a separation step.

### BRIEF DESCRIPTION OF FIGURES

FIG. 1: shows the parity plot of simulated and experimental values for the Ru-containing low temperature NH₃ reforming catalytic material according to Reference Example.

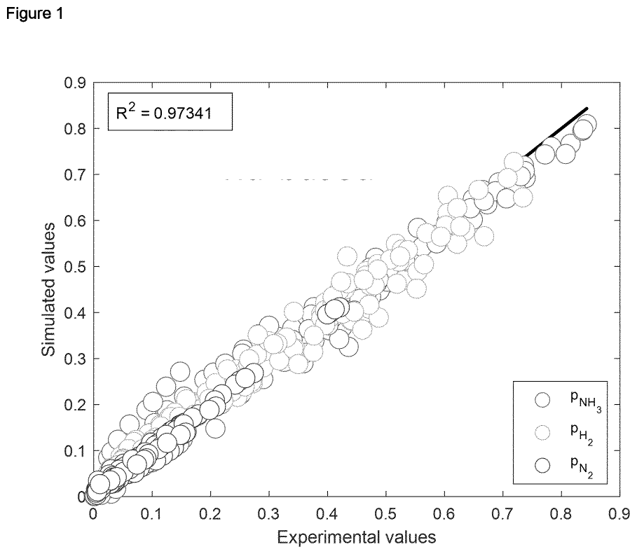

### CITED LITERATURE

U.S. Pat. No. 8,961,923 B2
U.S. Pat. No. 8,691,182 B2
U.S. Pat. No. 8,464,515 B2
WO 2019/038251 A1
Banares-Alcantara et al. in Applied Energy 2021, 282, 116009

1-15. (canceled)

16. A process for NH₃ reforming, the process comprising
(i) feeding a feed stream comprising NH₃ into a reactor unit, wherein the reactor unit has a reactor unit inlet and a reactor unit outlet, wherein the reactor unit comprises a catalytic material;
(ii) contacting the feed stream with the catalytic material in the reactor unit, for obtaining a product stream comprising H₂, N₂, NH₃, and optionally H₂O, wherein contacting is performed at a pressure in the range of from 1 to 100 bar(abs) and at a temperature in the range of from 50 to 750° C.;
(iii) optionally separating H₂O in the product stream obtained in (ii) for obtaining a dehydrated product stream comprising H₂, N₂, and NH₃;
(iv) separating NH₃ from the product stream obtained in (ii) or from the dehydrated product stream obtained in (iii) for obtaining a purified product stream comprising N₂ and H₂; and
(v) recycling the separated NH₃ obtained in (iv) to (i).

17. The process of claim 16, wherein from 90 to 100 volume-% of the feed stream according to (i) consist of NH₃.

18. The process of claim 16, wherein feeding the feed stream into the reactor unit according to (i) is performed at a gas hourly space velocity in the range of from 400 to 40,000 h⁻¹.

19. The process of claim 16, wherein contacting according to (ii) comprises transferring heat from a reaction of a chemical conversion process, wherein transferring heat is conducted using a heat exchanger or a heat pump.

20. The process of claim 19, wherein the heat which is transferred is obtained from an exothermic reaction or wherein the heat which is transferred is excess heat of the heat employed for performing an autothermal reaction or an endothermic reaction.

21. The process of claim 16, wherein the reactor unit comprises one or more reactors, wherein the catalytic material is comprised in the one or more reactors.

22. The process of claim 21, wherein each of the one or more reactors independently from one another is selected from the group consisting of a polytropic reactor, a two-stage reactor, an adiabatic reactor and a combination of a polytropic and an adiabatic reactor.

23. The process of claim 21, wherein each of the one or more reactors independently from one another is tubular.

24. The process of claim 21, wherein the reactor unit comprises, wherein the reactor unit inlet is the reactor inlet and wherein the reactor unit outlet is the reactor outlet.

25. The process of claim 21, wherein the reactor unit comprises, two or more reactors, the two reactors being a first reactor and a second reactor, wherein the first reactor is arranged upstream of the second reactor, wherein the first reactor has a first reactor inlet and a first reactor outlet, wherein the reactor unit inlet is the first reactor inlet and wherein the reactor unit outlet is the second reactor outlet,
wherein feeding according to (i) and contacting according to (ii) comprises
(i.1) feeding the feed stream comprising NH₃ into the first reactor, for obtaining an intermediate stream;
(ii.1) contacting the feed stream with the catalytic material in the first reactor, wherein contacting is performed at a pressure in the range of from 1 to 100 bar(abs) and at a temperature in the range of from 50 to 750° C.;
(i.2) feeding the intermediate stream obtained in (i.1) into the second reactor; and
(ii.2) contacting the intermediate stream with the catalytic material in the second reactor, wherein contacting is performed at a pressure in the range of from 1 to 100 bar(abs) and at a temperature in the range of from 50 to 700° C.;
for obtaining the product stream comprising H₂, N₂, NH₃, and optionally H₂O.

26. The process of claim 16, wherein the reactor unit comprises one or more reactors, and wherein the catalytic material is comprised by one or more of the one or more reactors.

27. The process of claim 16, wherein the catalytic material comprises a metal M1, wherein M1 is Ni, Co, or Ni and Co.

28. The process of claim 16, wherein the catalytic material comprises Ru and one or more support materials, wherein Ru is supported on the one or more support materials, wherein the one or more support materials display a BET surface area of 20 m²/g or more, and wherein the catalytic material contains 1 wt.-% or less of Ni and Co calculated as the respective element and based on 100 wt.-% of the catalytic material.

29. The process of claim 16, wherein the catalytic material comprises Ni, Ru, and a promoter metal M1′, wherein the catalytic material displays an Ru: Ni weight ratio in the range of from 0.0001:1 to 0.5:1, wherein the promoter metal M1′ is selected from the group consisting of Li, K, Na, Cs, Mg, Ca, Sr, and Ba, including mixtures of two or more thereof, and wherein the catalytic material further comprises one or more support materials onto which Ni, Ru, and the promoter metal M1′ are respectively supported.

30. The process of claim 16, further comprising after (iv) and prior to (v) expanding the NH₃ obtained in (iv).
